(19) United States
(12) Patent Application Publication
(10) Pub. No.: US 2015/0106197 A1
(43) Pub. Date: Apr. 16, 2015

(54) CROWDSOURCED INCENTIVES AND MANAGEMENT OF SAME

(71) Applicant: Cox Target Media, Inc., Atlanta, GA (US)

(72) Inventors: Loren C. Bendele, Pacific Palisades, CA (US); Joseph S. Zulli, Santa Barbara, CA (US); Christopher S. Tyler, Los Angeles, CA (US)

(21) Appl. No.: 14/515,492

(22) Filed: Oct. 15, 2014

Related U.S. Application Data
(60) Provisional application No. 62/059,806, filed on Oct. 3, 2014.
(60) Provisional application No. 61/891,385, filed on Oct. 15, 2013.

(51) Int. Cl. G06Q 30/02; G06F 17/30

(52) U.S. Cl. CPC G06Q 30/0253; G06F 17/30867
USPC 705/14.51

(57) ABSTRACT

Aspects of the disclosure related to configuration, delivery, and/or consumption of commercial incentives for products and/or services. In certain aspects, promotional content that may be related to a commercial incentive can be delivered and/or consumed.

### CROSS-REFERENCE TO RELATED APPLICATIONS

This application claims the benefit of U.S. Provisional Application No. 61/891,385, filed Oct. 15, 2013, and U.S. Provisional Application No. 62/059,806, filed Oct. 3, 2014, each of which is hereby incorporated herein by reference in its entirety.

### BACKGROUND

Merchants generally distribute incentives for merchandise in the form of promotions, coupons, cash back, and/or other discounts. The distribution is usually limited to one or a few outlets administered by or otherwise associated with the merchant. Such outlet(s) can include, for example, printed media, web-based portals, or digital platforms, and the incentives are usually specific to the outlet in which they are distributed.

### BRIEF DESCRIPTION OF THE DRAWINGS

The accompanying drawings form part of the disclosure and are incorporated into the subject specification. The drawings illustrate example embodiments of the disclosure and, in conjunction with the present description and claims, serve to explain, at least in part, various principles, features, or aspects of the disclosure. Certain embodiments of the disclosure are described more fully below with reference to the accompanying drawings. However, various aspects of the disclosure can be implemented in many different forms and should not be construed as being limited to the implementations set forth herein. Like numbers refer to like elements throughout.

FIG. 1 presents an example of an operational environment for generation and consumption of incentives in accordance with one or more embodiments of the disclosure.

FIG. 2 illustrates an information cycle associated with incentive information injection, incentive information aggregation, and incentive information consumption in accordance with one or more embodiments of the disclosure.

FIG. 3A presents an example of a user interface (UI) for configuration of incentives in accordance with one or more embodiments of the disclosure.

FIG. 3B presents an example of another UI for configuration of incentives in accordance with one or more embodiments of the disclosure.

FIG. 3C presents example records representative of incentives in accordance with one or more embodiments of the disclosure.

FIGS. 4-5 present example UIs in accordance with one or more aspects of the disclosure. The example UI in FIG. 4 conveys incentives in accordance with certain aspects of the disclosure, and the example UI in FIG. 5 illustrates matchup content in accordance with other embodiments of the disclosure.

FIG. 6 presents an example UI that conveys predetermined incentives (e.g., favorite products (also referred to as “faves”)) in accordance with one or more embodiments of the disclosure.

FIGS. 7-8 present example UIs that permit configuration of desired or otherwise preferred incentives in accordance with one or more embodiments of the disclosure.

FIGS. 9-10 present other example UIs that convey predetermined incentives (e.g., most incentivized products (which also may be referred to as “best deals” or “best”)) in accordance with one or more embodiments of the disclosure.

FIG. 11 presents an example of a UI that permits accessing predetermined incentives in accordance with one or more embodiments of the disclosure.

FIG. 12 presents an example of a UI conveying predetermined incentives in accordance with one or more embodiments of the disclosure.

FIG. 13A presents an example of a UI for conveying an incentive in accordance with one or more embodiments of the disclosure.

FIG. 13B presents an example of a UI conveying the incentive shown in FIG. 13A and matchup content in accordance with one or more embodiments of the disclosure.

FIG. 14 presents an example of a UI that permits accessing another interface to compare incentives in accordance with one or more embodiments of the disclosure.

FIG. 15 presents an example of a UI that permits selecting merchants for comparison of incentives amongst the selected merchants in accordance with one or more embodiments of the disclosure.

FIG. 16 presents an example of UI conveying a comparison of incentives between merchants in accordance with one or more embodiments of the disclosure.

FIGS. 17A, 17B, and 17C present examples of UIs that permit accessing and/or managing lists of desired items (e.g., a shopping list, a favorites list) in accordance with one or more embodiments of the disclosure.

FIG. 18 presents example of UIs that permit configuring the access to incentives and/or matchups, and accessing support functionality.

FIG. 19 presents an example of a consumption device of the operational environment in FIG. 1 in accordance with one or more embodiments of the disclosure.

FIG. 20 presents an example UI that permits consumption of incentives in accordance with one or more embodiments of the disclosure.

FIG. 21 presents an example of a UI that conveys promotional content in accordance with one or more embodiments of the disclosure.

FIG. 22 presents another example of a UI that conveys promotional content in accordance with one or more embodiments of the disclosure.

FIG. 23 presents yet another example of a UI that conveys promotional content in accordance with one or more embodiments of the disclosure.

FIG. 24 illustrates an example of an operational environment for consumption of promotional content in accordance with one or more embodiments of the disclosure.

FIG. 25 presents a block diagram of a computing environment that can implement various embodiments of the present disclosure.

FIGS. 26-28 present examples of methods in accordance with one or more embodiments of the disclosure.

### DETAILED DESCRIPTION

The present disclosure recognizes and addresses, in at least certain aspects, the lack of centralized distribution of content indicative or otherwise representative of product incentives, such as grocery sale information and/or coupon information. The disclosure provides, in certain embodiments, a networked environment that permits ingestion (e.g., acquisition and/or retention) of incentive content, aggregation of at least a portion of such content, and distribution of incentive content that is ingested or aggregated. Aggregated incentive content can include content indicative or otherwise representative of a sale price of a product offered by a retailer that is matched or otherwise associated with an incentive (e.g., a coupon or other type of discount) for the a product. Such content may be herein referred to as “matchup content.” In certain embodiments, matchup content can include printable coupons, and many of these coupons may have an affiliate relationship where the coupon's publisher receives a fee for each coupon printed from an interface (e.g., a web interface) associated with a device (such as a server) of the publisher. It should be appreciated that matchup content also may be associated with a service, where a sale price of a service offered by a service provider is matched or otherwise associated with an incentive for the service. Incentive content can include information indicative or otherwise representative of sales of consumer packaged goods (CPGs), other products, or services; coupon information for CPGs, other products, or services; a combination thereof, or the like. The incentive content in accordance with aspects of the disclosure can have monetary value, non-monetary value, or a combination thereof

In certain implementations, incentive content can be received or otherwise acquired from multiple sources, which can be distributed in space and can provide content that is specific to a geographical region or a confined area. For instance, the geographical region can include a city or a state, and the confined area can include a location having a specific ZIP code, a neighborhood, a specific merchant store, or the like. Accordingly, in one aspect, the incentive content may be referred to as community-generated incentive content or “crowdsourced” incentive content. In another aspect, the incentive content can be comprised of locally sourced incentive content (e.g., local grocery deals, such as “free loaf of bread with purchase of two gallons of milk”). Such content can be matched up with a CPG incentive, e.g., “Save $1.00 on one gallon of Elsie Borden® milk.”

In connection with distribution of incentive content, in at least certain implementations, the disclosure provides several interface units that can permit consumption at a computing device (which may be referred to herein as an “electronic device” or a “device”). The computing device can be embodied in a device having specific functionalities and form factor, can generally include one or more processors and one or more memory devices; communication devices (e.g., a system bus, a memory bus, or the like); input/output interface(s) that can include display device(s); and/or a radio unit for wireless communication. More specifically, in one example, a device in accordance with this disclosure can be embodied in a tethered computing device or a portable computing device, such as a mobile tablet computer, an electronic-book reader (also referred to as e-reader), a mobile telephone (e.g., a smartphone), and the like. In another example, the device can be embodied in or can include a wearable computing device, such as watch, goggles or head-mounted visors, or the like. In yet another example, the device can be embodied in or can include portable consumer electronics equipment, such as a camera, a media reproduction device, a portable television set, a gaming console, a navigation device, a voice-over-internet-protocol (VoIP) telephone, and the like.

In one example implementation, an interface unit can be embodied in or can include an application programming interface (API) that can receive incentive content from a network node (e.g., a server, a gateway, a switch, a router, or other computing device that permits or otherwise facilitates communication with the interface unit). The API can be configured (e.g., installed, provisioned, and/or activated) within a computing device (mobile or otherwise) that permits publication of content in a network (e.g., a wide area network, such as the Internet). In one aspect, the API can permit a network node of the network to communicate (e.g., transmit or push) at least a portion of the incentive content to the computing device having the API configured thereon. In another example implementation, an interface unit can be embodied in or can include a mobile application that can permit acquisition of incentive content at a mobile device, and rendering of at least a portion of such content at the mobile device. As utilized in the this disclosure, in at least certain embodiments, the term “render” and its variations, such as “rendering” or “rendered,” and the term “display” and its variations are utilized interchangeably. In other embodiments the term “render' can refer to processing or otherwise operating on data and/or metadata prior to displaying the resulting data and/or metadata. The incentive content acquired at the mobile device can include (i) sale information specific to a location associated with the mobile device (e.g., the location of the mobile device, a location within certain distance from the mobile device, or the like); (ii) coupon information specific to such a location; and/or (iii) information indicative of matched incentives associated with the sale information.

It should be appreciated that, in one example, the disclosed interface units that permit consumption of incentive content also can permit or otherwise facilitate monetization of distribution of the incentive content. In one example scenario, incentive content for a provider (e.g., a retailer or service provider) can be syndicated to a group of interface units configured at respective source(s) of provider-specific incentive content (e.g., sale information for a specific retailer or service provider). In such a scenario, one of the respective source(s) can receive sale information and/or matchup content for the provider based at least in part on a specific content distribution agreement, such as a content subscription, delivery of predetermined content volume, delivery of content based on a predetermined event, a combination thereof, or the like. To at least such an end, in one aspect, the disclosure provides a network platform (e.g., servers, repositories, and/or access networks) that can generate and/or can communicate incentive content in accordance with the distribution agreement. It should be appreciated that, in another aspect, the syndicated incentive content can be updated at least in accordance with the distribution agreement. For instance, an information structure indicative of incentive content (e.g., an affiliate hypermedia link (or affiliate link) and information attained therefrom) can be updated in response to incentive content being pushed to a source (e.g., a publisher). Therefore, in one aspect, such an information structure can be updated automatically.

In one embodiment, a mobile device comprising an interface unit and/or other units in accordance with one or more aspects of this disclosure can permit an end-user associated with the mobile device to access specific views of incentive content available at a network platform. In addition or in the alternative, the interface unit can permit the mobile device to receive notifications associated with specific incentives, such as a notification of a predetermined product (e.g., a favorite product or otherwise desired product) being on sale or otherwise incentivized. For instance, the notification can convey that a bonus monetary incentive or non-monetary benefit is available for the product that is on sale or otherwise incentivized. It should be appreciated that, in one aspect, a notification can be received or accessed at the mobile device in response to a notification criterion associated with the incentive content available at the network platform being satisfied.

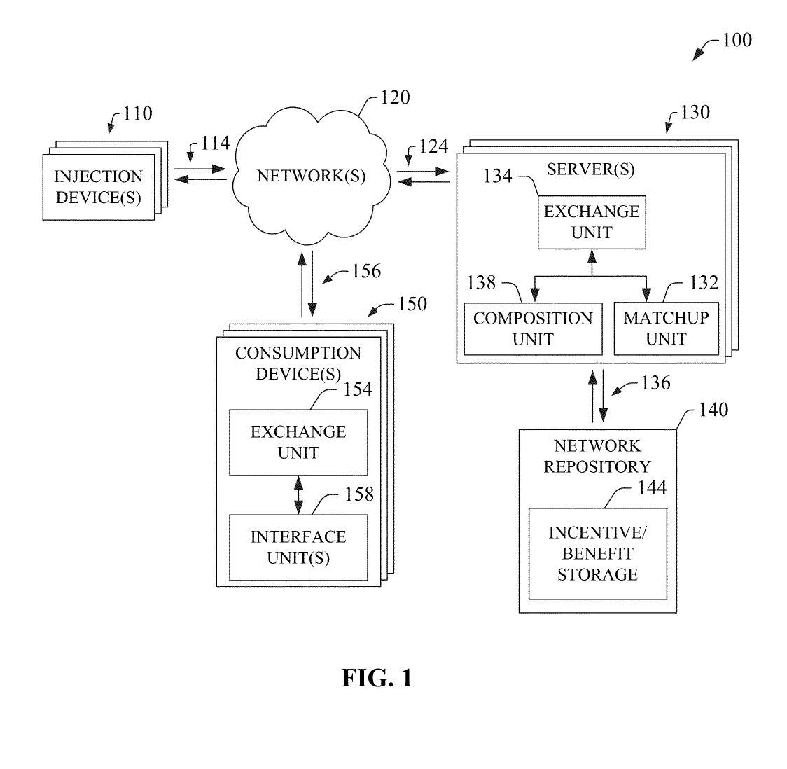

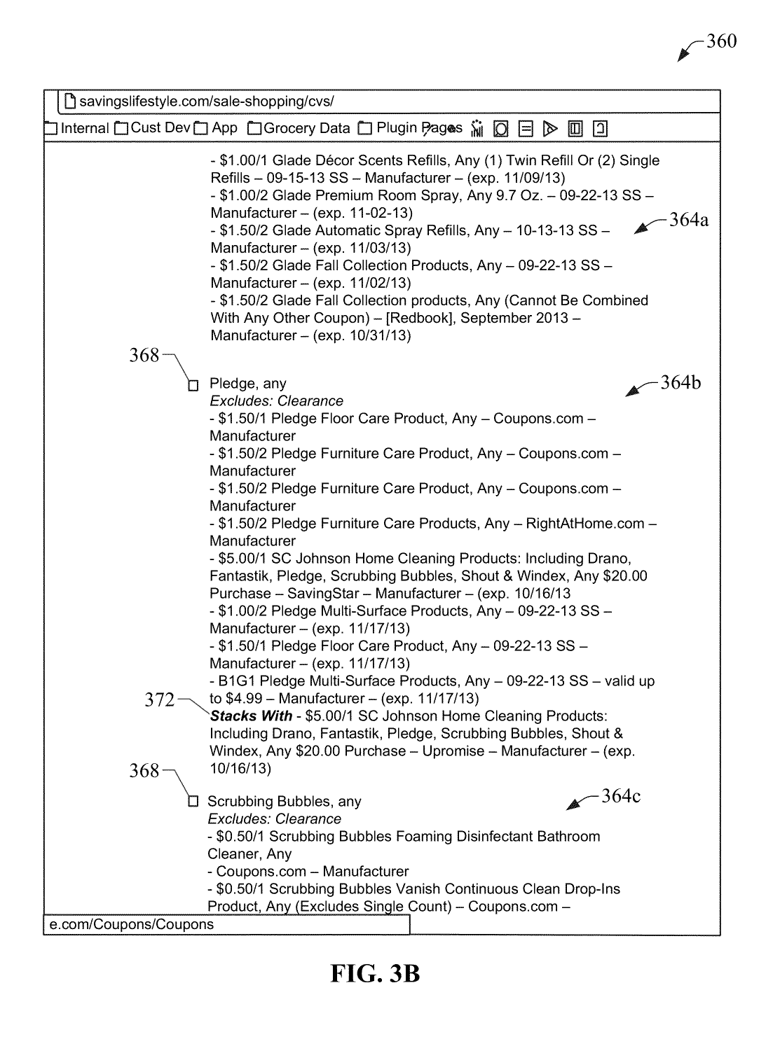

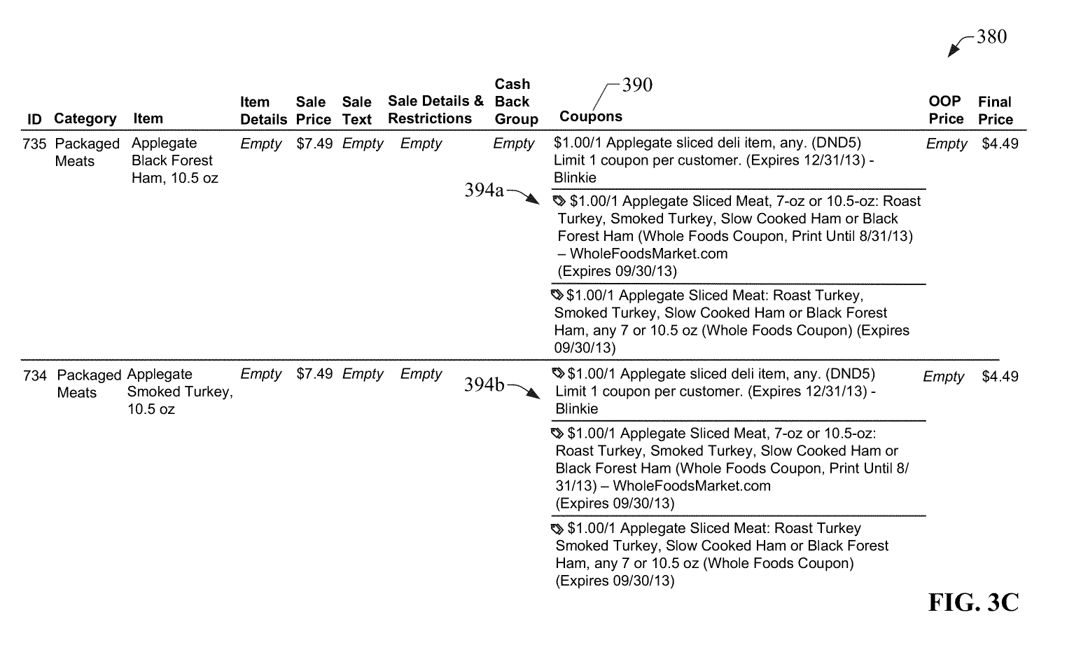

Referring to the drawings, FIG. 1 illustrates an example operational environment 100 for crowdsourced incentives and management thereof in accordance with one or more aspects of the disclosure. The example operational environment 100 includes a group of one or more devices 110 (which also may be referred to herein as injection device(s) 110) that can communicate incentive information to a remote network platform via one or more networks 120. In one example, each of the injection device(s) 110 may be referred to as a source, and can be embodied in or can include a device associated with a grocery blogger, a device associated with a culinary blogger device, a device associated with healthy lifestyle blogger, a device associated with a fitness blogger, or a devices associated with a merchant or a representatives thereof. In order to communicate incentive information, in one implementation, each one of the injection device(s) 110 can be functionally coupled to the network 120 via data and signaling communication link(s) 114 that can permit communication of the incentive information (e.g., data, metadata, and/or signaling) to one or more network nodes of the network 120. The network(s) 120 can include wireless network(s), wireline network(s), or a combination thereof), and the data and signaling communication link(s) 114 can include, for example, wireline link(s), wireless link(s), a combination thereof, or the like. In certain embodiments, at least one of the injection device(s) 110 can transmit incentive information at specific time intervals (e.g., on a weekly basis, daily basis, or the like). The incentive information can include, for example, sale information for a CPG at a specific retailer, a coupon for the CPG, a combination thereof, or the like. In addition, in one aspect, the incentive information can be formatted in accordance with a predetermined information structure indicative or otherwise representative of a specific incentive (which, in certain embodiments, may also be referred to as a deal). In certain implementations, an injection device of the injection device(s) 110 can receive the incentive information from an end-user. Accordingly, in one aspect, the incentive information may be user-generated or crowsourced. As an example, as explained in greater detail hereinafter, FIGS. 3A-3B present user interfaces (UIs) that can permit an injection device to transmit or otherwise provide incentive information.

As illustrated, at least one of the network(s) 120 can be functionally coupled (e.g., communicatively coupled) to a network platform via data and signaling communication link(s) 124 (e.g., wireline link(s), wireless link(s), a combination thereof, or the like) that can permit communication of incentive information to at least one of a group of servers 130. In one aspect, the group of servers 130 may be referred to as server(s) 130, and each one of server(s) 130 can be functionally coupled to a network repository 140 via one or more data and signaling communication link(s) 136 (e.g., wireline link(s), wireless link(s), a combination thereof, or the like). Accordingly, in one aspect, a server of the server(s) 130 can receive inventive information (e.g., incentive data and/or incentive metadata) from at least one of the injection device(s) 130. In one example, each of the server(s) 130 can include an exchange unit 134 that can receive at least a portion of the incentive information. In one aspect, such a server can process at least a portion of the incentive information that is received and can generate an incentive record (e.g., a deal) comprising one or more information objects (e.g., a field, a primary key, a secondary key, a combination thereof, or the like). In yet another aspect, such a server can retain the incentive record in an incentive/benefit storage 144 (e.g., a relational database) within the network repository 140. To at least such an end, in one aspect, the server can transmit information indicative of the incentive record to an information manager server (not shown) within the repository 140, and the information manager server can retain the information indicative of the incentive record in one or more memory devices comprising the incentive/benefit storage 144. In certain implementations, the server of the server(s) 130 that processes incentive information can include a composition unit 138 that can organize the received incentive information into categories. Each of such categories can be indicative of a specific class of incentive and/or type of CPG or service associated with the incentive information (e.g., a deal) represented by at least a portion of the incentive information. As an example, as described in greater detail below, FIG. 3C illustrates examples of incentive records, each having information objects representative of the respective incentive record. The categories can include for example, produce; packaged meats; frozen foods; meat, poultry and fish; deli; dairy; home supplies; and the like.

The incentive/benefit storage 144 also can include benefit information (e.g., one or more records) indicative or otherwise representative of incentives having monetary value or non-monetary value. Such incentives can include coupons and/or other discounts (such as cash back (e.g., Cash Back at Register, such as Kroger Mega Events, Ibotta, Savingstar (SS)) and/or retailer store credits (e.g., CVS Extracare Bucks, Walgreens Register Rewards, or the like). In one aspect, a server of the server(s) 130 can include a matchup unit 132 that can process at least a portion of the incentive information (e.g., deals) that is received from at least one of the group of injection devices 110 and at least a portion of the benefits information (e.g., coupons and/or other discounts). In response to such processing, the matchup unit 132 can generate a group of matched incentives and benefits. For instance, the group of matched incentives and benefits can include at least one pair comprising a deal for a CPG and a valid coupon for the CPG. Such a server can retain at least a portion of the group of matched incentives and benefits in the network repository 140, within the incentive/benefit storage 144, for example. Information indicative or otherwise representative of the group of matched incentives and benefits may be referred to herein as matchup content. In one embodiment, the composition unit 138 that may be included in at least one (e.g., one, two, more than two, or each) of the server(s) 130 can process the incentive information and benefit information, and can produce matched incentives (e.g., deals) and benefits (e.g., coupons and/or discounts).

As illustrated, the example operational environment 100 can include a group of consumption devices 150 (which may be referred to herein as consumption device(s) 150) that can be functionally coupled to the network 120 via one or more data and signaling communication link(s) 156 (e.g., wireline link(s), wireless link(s), a combination thereof, or the like). Each of the consumption device(s) 150 can be embodied in or can include a computing device having computing resources including processor(s), memory device(s) (or memory), input/output interface(s), and communication architectures, such as bus architectures, radio units, combinations thereof, or the like. In certain embodiments, each of the consumption device(s) 150 can include respective mobile application(s), blog plugin(s), web-based interface(s), social network feed(s), or other tool(s) or unit(s), such as a tool that can permit identification of specific benefits (e.g., coupons or discounts) based on specific consumers and/or contemporaneous or historical redemption information. While illustrated as separate blocks, in certain embodiments, a consumption device of the consumption device(s) 150 can embody or can include an injection device of the injection device(s) 110, or vice versa. In the illustrated embodiment, at least one of the consumption device(s) 150 can comprise an exchange unit 154 and one or more interface units 158. In one aspect, at least one of the interface unit(s) 158 can render or otherwise present incentive information, benefit information, and/or matchup content. Such information and/or content can be rendered or otherwise presented in accordance with predetermined views of the incentive/benefit storage 144. As utilized herein, a view of a database or other information structure may refer to a set of information that is present in the database or information structure and that satisfies one or more criteria. Accordingly, a consumption device of the consumption device(s) 150 can comprise an exchange unit 154 that can receive incentive information, benefit information, and/or matchup content from at least one server of the server(s) 130. In one aspect, as described herein, at least one server of the server(s) 130 can include an exchange unit 134 that can select or otherwise determine a view of the incentive/benefit storage 144, and can communicate (e.g., push) such a view to the consumption device. Communication of the view may be accomplished via communication of information indicative or otherwise representative of the view. In one example, the view can be communicated (e.g., pushed) by the exchange unit 134 in response to one or more of (i) a request or query received from the exchange unit 154; (ii) fulfillment of a delivery criterion for transmission of the view; or (iii) an update to incentive information and/or benefit information associated with the view. The exchange unit 154 can receive a view of the incentive/benefit storage 144 and can communicate at least a portion of the view to the interface unit 158 in response to an indication that the view has been selected via the interface unit 158.

In certain embodiments, a view of the incentive/benefit 144 can identify or otherwise extract incentive information (e.g., sale information) and/or benefit information (e.g., coupons and/or discounts), where matchup content associated with the view can include coupons or discounts for historical staple goods redeemed by a consumer. Such a view can permit a consumer to be aware or otherwise notified of the incentivized staple goods of interest to the consumer, thus allowing the consumers to stock up on products that are historically preferred or staple goods for the consumer. In one example scenario, a view associated with staple products can be generated in response to a staple good being on sale at a discounted price. In such a scenario, the composition unit 138 can generate such a view, and the exchange unit 134 can transmit (e.g., push) information indicative of the view to a consumption device of the consumption device(s) 150.

It should be appreciated that, in one aspect, the exchange unit 134 can swap in appropriate affiliate links for a publisher of matched up content for the publisher (e.g., the consumption device or the injection device) that the exchange unit 134 is delivering matchup content to.

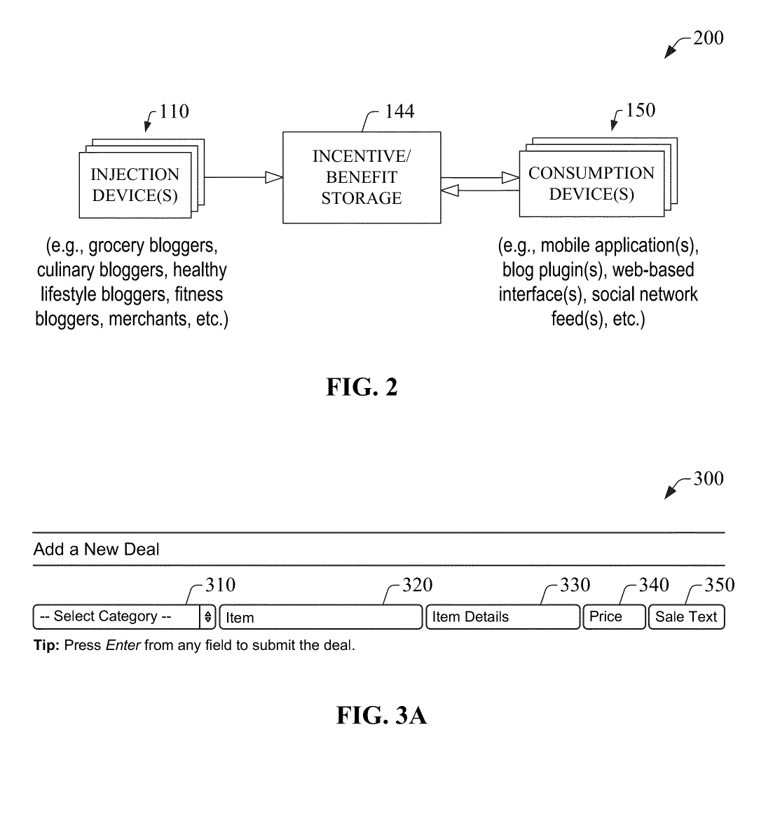

The exchange of information representing a cycle of injection and consumption of incentive information described herein is pictorially represented in the diagram 200 in FIG. 2. In diagram 200, the group of injection devices 110 (also herein referred to as sources) can be embodied in or can include a group of devices associated with grocery bloggers; a group of devices associated with culinary blogger devices; a group of devices associated with healthy lifestyle bloggers; a group of devices associated with fitness bloggers; a group of devices associated with deal clearinghouses or other aggregators of deal information; and/or a group of devices associated with merchants or representatives thereof. A one-directional arrow illustrates the flow of incentive information from one or more of the injection devices 110 to the incentive/benefit storage 144, which can be embodied in or can include a sale/coupon database. Two one-directional arrows illustrate exchange of incentive information between the incentive/benefit storage 144 and one or more of the consumption device(s) 150. For example, one of the consumption device(s) 150 can communicate a query and/or other signaling to the incentive/benefit storage 144 and, in response, the incentive/benefit storage 144 can communicate a view of incentive information that satisfies the query and/or signaling.

As described herein, one or more of the consumption device(s) 150 can communicate other signaling to the incentive/benefit storage 144 in order to configure specific views of the incentive information that may be available at the incentive/benefit storage 144. Therefore, as exemplified in the diagram 200, consumption device(s) 150 and/or injection device(s) 110 can include respective mobile application(s), blog plugin(s), web-based interface(s), social network feed(s), and/or other tool(s), such as a tool that can permit identification of specific benefits (e.g., coupons or discounts) based on specific consumers and/or contemporaneous or historical redemption information. In certain embodiments, consumer information and/or redemption information can be retained in the network repository 140. For instance, at least a portion of the consumer information (e.g., preferred retailers, preferred retailer stores, preferred products and/or services, a combination thereof, or the like) and/or at least a portion of the redemption information can be retained in the incentive/benefit storage 144 and/or other memory elements (e.g., a consumer profile or a redemption profile) within the network repository 144. In other embodiments, consumer information and redemption information can be retained in respective information storages (not depicted in FIG. 2), which may be functionally coupled to one or more of the server(s) 130 shown in FIG. 1.

FIG. 3A illustrates an example of a user interface 300 that can be rendered at an injection device of the injection device(s) 110 in order to provide incentive information, such as a deal or sale. The example user interface can include selectable options 310-350 that can permit inputting incentive information. The selectable options include actionable indicia 310, which can be actuated in order to select a category for the incentive information. For instance, such a category can refer to a category of consumer packaged goods (e.g., packaged meats, deli, dairy, or the like). In addition, the selectable options 320-350 can include a fillable form having four fields that permit inputting information that characterizes the incentive information. More specifically, indicia 320 represents a first field whereby information indicative or otherwise representative of an “item” associated with the selected category can be provided. In addition, indicia 330 represents a second field whereby information indicative or otherwise representative of “item details” associated with the item in the first field can be provided. Further, indicia 340 can represent a third field whereby “price” of the item in the first field can be provided. Furthermore, indicia 350 can represent a fourth field whereby information (e.g., “Sale Text”) that further characterizes the incentive can be provided. The injection device that renders the example user interface 300 can receive the incentive information entered via one or more of the selectable options 310-350, and can communicate at least a portion of the incentive information to at least one of the server(s) 130, which can communicate the received incentive information to the incentive/benefit 144 storage.

FIG. 3B presents an example of a user interface 360 that can present benefit information that may be selected for generation of matchup content. As illustrated, the user interface 360 can include groups 364a, 364b, and 364c of benefit information (e.g., coupons), each for a specific category of products, for example. As described herein, the injection device of the injection device(s) 110 that renders the user interface 360 can receive the benefit information on syndication from the network platform including the incentive/benefit storage 144. In addition or in the alternative, such an injection device can receive benefit information from an end-user or other input sources. The user interface 360 also can include benefit information 372 indicative or otherwise representative of benefits that may be combined with other benefits within a category in order to achieve greater savings. Further, the user interface 360 can include selectable indicia 368 that, in response to selection, can cause the injection device to communicate the selected benefit information at least one of the server(s) 130 in order to generate matchup content.

FIG. 3C presents a diagram 380 that illustrates matchup content that can be generated by a server of the server(s) 130 that can receive incentive information via the example user interface 400. As described herein, in one embodiment, such a server can include the matchup unit 132 that can generate the matchup content. In the diagram 380, two matchup records respectively associated with two items on sale are illustrated. Each of the illustrated matchup records can include a coupon record 390 (referred to as “coupons 390”). In addition, the two matchup records can have respective groups of coupons 394a and 394b, each of the groups having the same three coupons in view that each of those coupons can be matched to the category and/or brand of each of the items on sale.

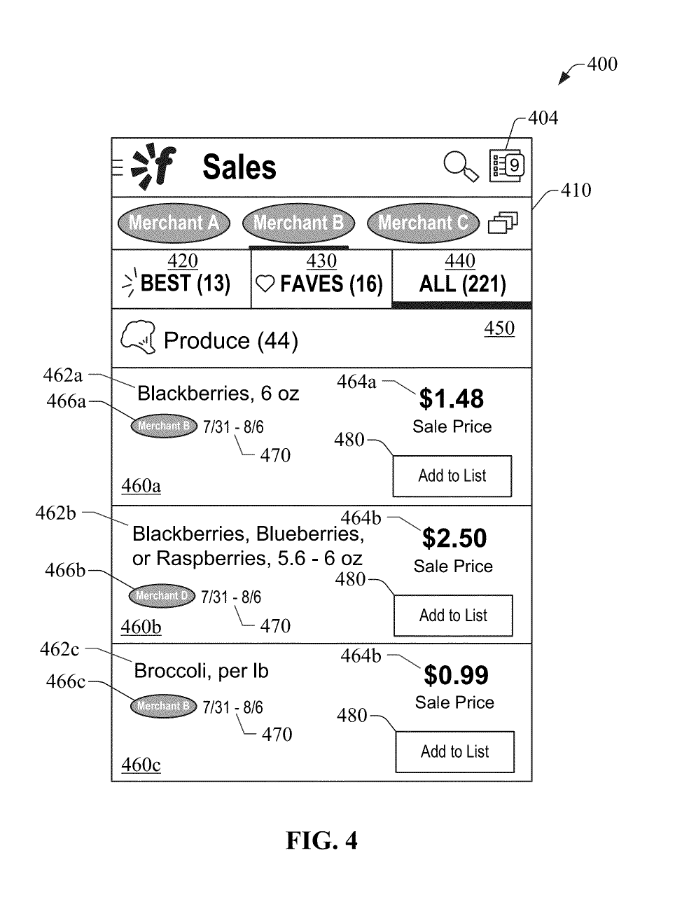

As described herein, a consumption device of the consumption device(s) 150 can obtain and present views of incentive information, benefit information, and/or matchup content. As such, the consumption device can utilize or otherwise leverage the interface unit 158 described herein. More specifically, in one example, the interface unit 158 can render a user interface having selectable options that permit or otherwise facilitate obtaining and rendering specific information from the incentive/benefit storage 144. In certain implementations, the selectable options can be embodied in or can include actionable indicia that can be actuated and, in response to actuation, can cause the consumption device to obtain specific information from the incentive/benefit storage 144. In addition, the user interface that can be rendered also can present notification indicia indicative or representative of notification(s) available for the consumption device. One or more of the notification(s) can convey incentive information for preferred products and/or services, or incentive information, such as deals, provided by a preferred retailer. The notification indicia can be actionable and, in response to actuation, can cause the consumption device to render or otherwise present one or more of the available notification(s). FIG. 4 illustrates an example of a user interface 400 that permits access to incentive information from the incentive/benefit storage 144. The example user interface 400 includes notification indicia 404, which can include markings (e.g., “9”) indicative or otherwise representative of a number of notifications available for the consumption device that renders the example user interface 400. The example user interface 400 also includes a banner 410 that includes indicia representative of merchants for which incentive information, benefit information, and/or matchup content may be available at the incentive/benefit storage 144. In one aspect, the indicia in the banner 410 is actionable and, in response to actuation can cause the consumption device to select information at the incentive/benefit storage 144 that is associated with the selected merchant. For example, in the illustrated user interface 400, the indicia representative of “Merchant B” is selected (depicted with a black rectangle).

In addition, example user interface 400 presents indicia 420, 430, and 440, each of which is selectable or otherwise actionable, and can represent a category of incentives recorded at the incentive/benefit storage 144. As an example, the indicia 420 (labeled as “Best” in FIG. 4) represents the best incentives available for the merchant selected in the banner 410 (e.g., “Merchant B”) and, in response to actuation, can cause the consumption device that renders the user interface 400 to obtain incentive information representative of the best incentives for such a merchant. As another example, indicia 430 (labeled as “Faves” in FIG. 4) represents favorite or otherwise preferred incentives and, in response to actuation, can cause the consumption device to obtain incentive information representative of such incentives. Favorite or otherwise preferred incentives can be identified or otherwise indexed as such within the incentive/benefit storage 400. As yet another example, the indicia 440 (labeled as “All” in FIG. 4) represents all the incentives recorded at the incentive/benefit 144 storage for the selected merchant (e.g., “Merchant B”). As illustrated, each of the indicia 420, 430, and 440 can include a marking indicative of the number of records that pertain to the incentive category represented by such indicia.

The example user interface 400 also can include indicia 450, which is actionable and, in response to actuation, can cause the consumption device that renders the user interface 400 to access incentive information indicative or representative of incentives for certain categories of goods, products, and/or services. As an example, indicia 450 is labeled “Produce,” which conveys that the incentive information (e.g., sales information) obtained via actuation of the indicia 450 can cause the consumption device to obtain and render incentive information indicative of incentives in the produce category. In addition, the indicia 450 also can include markings (e.g., “(44)”) indicative of the number of incentives in the produce category retained within the incentive/benefit storage 144.

In addition, the user interface 400 can render or otherwise present a certain number of incentives for respective items in a specific incentive category. As illustrated, actuation of the indicia 450 can cause the rendering of incentive information for three items, wherein the incentive information may be presented in three banners 460a, 460b, and 460c including indicia representative of the incentive information. It should be appreciated that more or less than three may be rendered at a time based at least on the real state (or display space) available for presenting such incentives associated with respective items. In certain embodiments, the indicia rendered within the region spanned by the banners 460a, 460b, and 460c can be updated in response to interaction with a portion of such a region. For instance, the indicia can be scrolled up or down in response to a screen swipe or a screen tap. Similarly, the indicia can be scrolled sideways in response to a screen swipe. In the illustrated example, the banners 460a, 460b, and 460c include respective indicia 462a, 462b, and 462c, each representing or otherwise indicating the item associated with the incentive (e.g., the item on sale). The banners 460a, 460b, and 460c also include respective indicia 464a, 464b, and 464c, each representing or otherwise indicating a monetary value (e.g., a sale price) of the incentive. In addition, the banners 460a, 460b, and 460c also include respective indicia 466a, 466b, and 466c, each representing or otherwise indicating a merchant that provides the incentive.

Further, each of the banners 460a, 460b, and 460c can include indicia 470 indicative of a period (e.g., a week) during which the incentive is redeemable or otherwise active; and indicia 480 (labeled “Add to List” for the sake of illustration), which can be actionable and, in response to actuation, can cause the consumption device to supply or retain the incentive information that is being rendered. In addition or in other embodiments, actuation of indicia 480 can cause the consumption device that presents the example user interface 400 to transmit a notification or other signaling indicative of otherwise representative of selection of an item (e.g., an incentivized product or service) for addition to a customized list, such as a shopping list or favorite list. The notification or signaling can be transmitted to a server of the server(s) 130. In response to such signaling, in one implementation, a composition unit 138 in such a server can identify a comparable item with the item added to the list. The comparable product can be identified in numerous ways, including computing a similarity metric between the item added to the list and another product. The similarity metric can be determined as a difference (weighted or otherwise) between values assigned to variables that characterize a product, such as manufacturer, product type or category, popular metrics (e.g., how many times a product has been added to a list), and the like. In addition, the server can transmit a recommendation to peruse and/or add the comparable item to the list. Incentive information associated with the comparable item also can be transmitted to the consumption device. The recommendation and/or the incentive information can be presented as indicia in a pop-up window or a take-over interface, or in any other format suitable for presentation of hyperlinks, forms, content, and/or media.

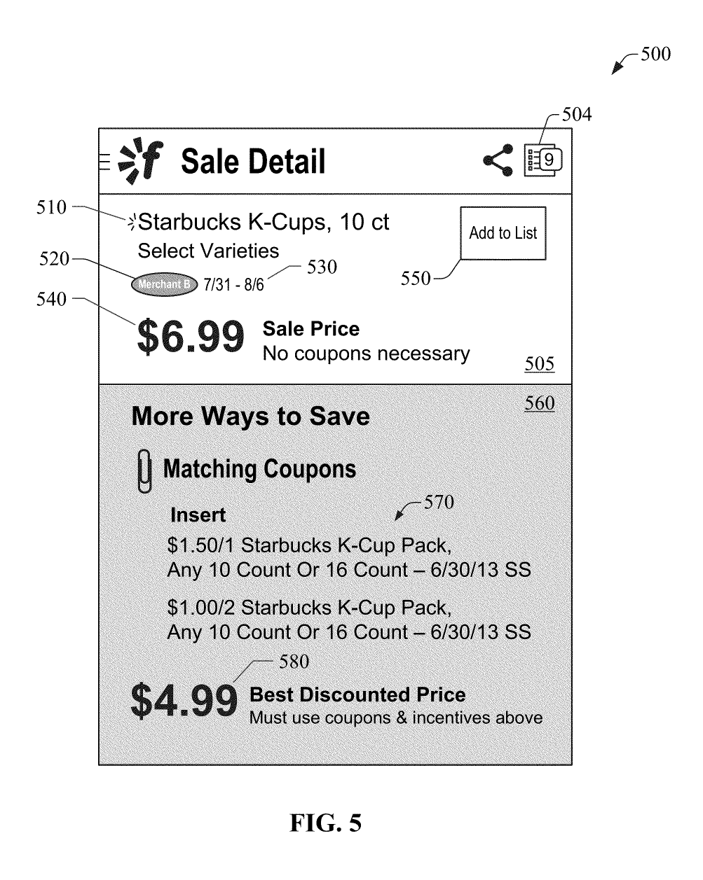

In certain embodiments, each of the banners 460a, 460b, and 460c, or a portion thereof, can be actionable and, in response to actuation, can cause the consumption device that provides the example user interface 400 to render indicia, actionable and/or non-actionable, that can convey details of the incentive presented in the actuated banner. As such, the consumption device can query the incentive/benefit storage 144 for matchup content available for the incentive presented in the actuated banner. In response to the query, the consumption device can receive the matchup content and can render at least a portion of the matchup content. FIG. 5 illustrates an example of a user interface 500 that can present details of an incentive (e.g., an item on sale) in accordance with one or more aspects of the disclosure. The user interface 500 can present a banner 505 that renders indicia representative of an item on sale. As illustrated, indicia 510 can represent the item on sale; indicia 520 and 530 can represent, respectively, a merchant that provides the incentive and a period during which the incentive is active; and indicia 540 can represent a monetary value (e.g., a sale price) of the incentive. The banner 505 also can include indicia 550, which is actionable and, in response to actuation, can cause the consumption device to supply and/or retain the incentive information presented via the banner 505. In addition, the user interface 500 can include a banner 560 than can convey matchup content via indicia 570 representative of coupons that match or are otherwise associated with the incentive conveyed by the banner 505. In addition, the banner 560 can present indicia 580 representative of a monetary value of the incentive after the monetary benefit of the matchup content has been accounted for.

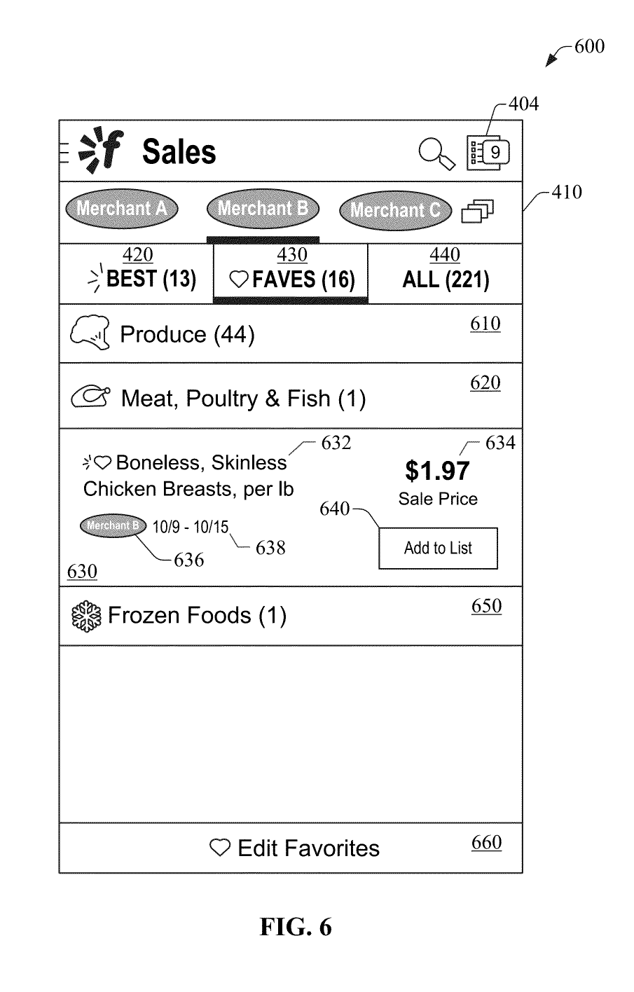

An interface unit of the interface unit(s) 158 that can be included in a consumption device of the consumption device(s) 150 can permit configuration of a preferred or otherwise desired view of the incentive/benefit storage 144. To at least such an end, in one example, the interface unit can render a user interface 600, as shown in FIG. 6, including actionable indicia that can permit such configuration. More specifically, the user interface 600 can render banners 610, 620, and 650 that convey preferred categories of preferred or otherwise desired incentives. Each of those banners can include markings (e.g., “(44),” “(1),” and “(1)”) indicative of a number of incentives available in a respective category. In response to actuation, each of the banners 610, 620, and 650 can cause the consumption device to render incentive information as described herein. For instance, actuation of banner 620 (which, for example, represents the “Meats, Poultry, and Fish” category and includes a single incentive) can cause the consumption device to render the banner 630, which conveys the available incentive information. As illustrated, the banner 630 includes indicia 632 representative of the item that is incentivized; indicia 634 indicative of the monetary value of the incentive; indicia 636 indicative of the merchant that provides the incentive; and indicia 638 indicative of a period during which the incentive is active. Similarly to other user interfaces described herein, the user interface 600 also includes actionable indicia 640 that, in response to actuation, can cause the consumption device to supply or retain the rendered incentive information.

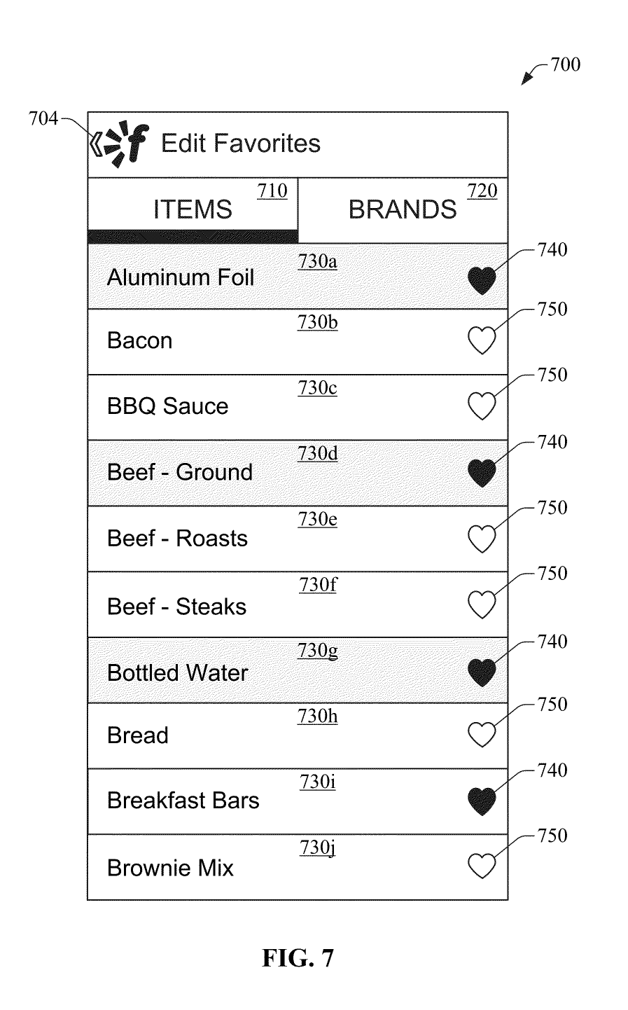

In addition, the user interface 600 can include actionable indicia 660 that, in response to actuation, can cause the consumption device that renders the user interface 600 to collect or otherwise receive input preference information indicative or otherwise representative of incentives that may be preferred or otherwise desired. As such, in one example, indicia 660 can be labeled “Edit Favorites” and, in response to selection or other interaction (such as a touch, screen tap, a screen swipe, or the like) can cause the consumption device to render another user interface that can permit inputting the preference information. FIG. 7 illustrates an example of a user interface 700 that can permit configuration of preferred or otherwise desired incentives in accordance with aspects described herein. As exemplified, the user interface 700 can include indicia 704 that is actionable and, in response to actuation, can cause the consumption device to stop rendering the user interface 700 and render another user interface, such as example user interface 600. In addition, the user interface 700 can include selectable indicia 710 that, in response to selection, can cause the consumption device to render a listing of item categories, which can be presented via respective actionable indicia. Each of the actionable indicia can include indicia that, when selected, can characterize the item category as a preferred category and can cause the consumption device to communicate an indication of the preferred category to at least one of the server(s) 130, shown in FIG. 1. As an example, selection of indicia 710 can cause the consumption device (e.g., a mobile computing device) to render actionable indicia 730a-730j representative of item categories for which incentive information is preferred or otherwise desired. Each of the actionable indicia 730a-730j can include selectable indicia that, in response to selection, can cause the consumption device to configure the selected item category as a preferred or otherwise desired item category. Selected indicia, such as indicia 740, can be distinguishable from non-selected indicia, such as indicia 750. As such, in the example user interface 700, indicia 730a represents the “aluminum foil” item category and is selected as a preferred item; indicia 730b represents the “bacon” item category and is not selected as a preferred item; indicia 730c represents the “barbeque sauce” item category and is not selected as a preferred item; indicia 730d represents the “beef—ground” item category and is selected as a preferred item; indicia 730e represents the “beef—roasts” item category and is not selected as a preferred item; indicia 730f represents the “beef—steaks” item category and is not selected as a preferred item; indicia 730g represents the “bottled water” item category and is selected as a preferred item; indicia 730h represents the “bread” item category and is not selected as a preferred item; indicia 730i represents the “breakfast bars” item category and is selected as a preferred item; and indicia 730j represents the “brownie mix” item category and is not selected as a preferred item.

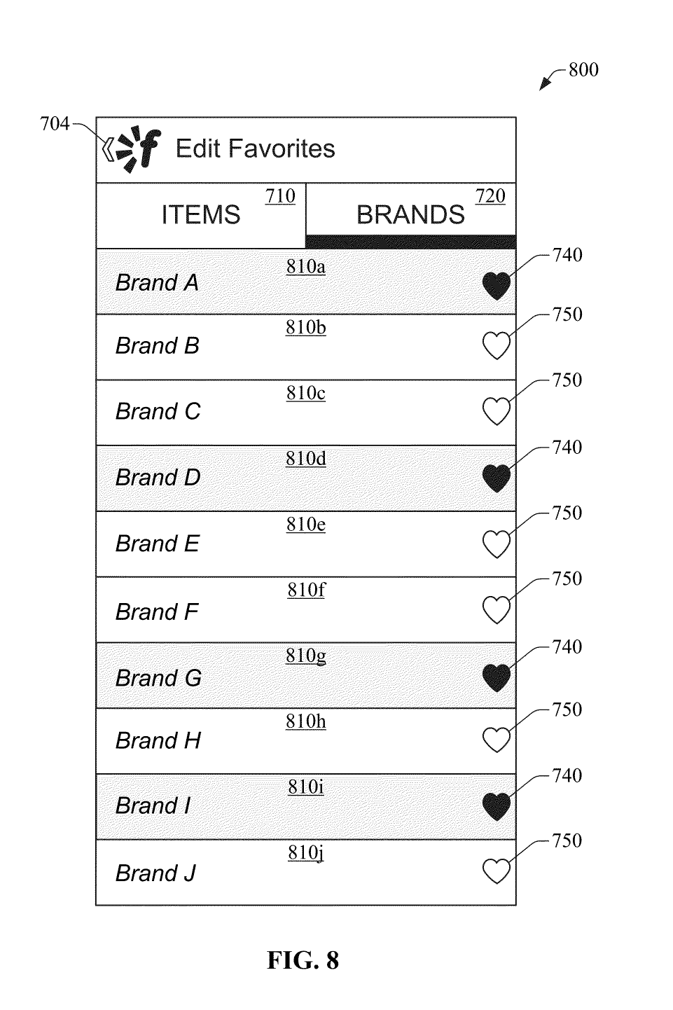

In addition or as an alternative to configuration of preferred item categories, the user interface 700 also can permit configuration of preferred brands. FIG. 8 illustrates an example of a user interface 800 that permits configuration of brand categories in accordance with aspects described herein. Selection of the indicia 720 can cause a consumption device (e.g., a mobile computing device) to render, via the interface unit 158, for example, actionable indicia 810a-810j representative of brand categories for which incentive information is preferred or otherwise desired. Each of the actionable indicia 810a-810j can include selectable indicia that, in response to selection, can cause the consumption device to configure the selected item category as a preferred or otherwise desired item category. Selected indicia, such as indicia 740, can be distinguishable from non-selected indicia, such as indicia 750. As such, in the example user interface 800, indicia 810a represents a brand category for “brand A” (e.g., Advil®) and is illustrated as being selected as a preferred category; indicia 810b represents a brand category for ‘brand B” (e.g., Arm and Hammer®) and is illustrated as not being selected as a preferred category; indicia 810c represents a brand category for “brand C” (e.g., Ball Park®) and is not selected as a preferred item; indicia 810d represents a brand category for “brand D” (e.g., Betty Crocker®) and is illustrated as being selected as a preferred brand; indicia 810e represents a brand category for “brand E” (e.g., Bounty®) and is illustrated as not being selected as a preferred item; indicia 810f represents a brand category for “brand F” (e.g., Cascadian Farm) and is illustrated as not being selected as a preferred category; indicia 810g represents a brand category for “brand G” (e.g., Charmin®) and is illustrated as being selected as a preferred category; indicia 810h represents a brand category for “brand H” (e.g., Coca-Cola®) and is illustrated as not being selected as a preferred category; indicia 810i represents a brand category for “brand I” (e.g., Colgate®) and is illustrated as being selected as a preferred category; and indicia 810j represents a brand category for “brand J” (e.g., Cottonelle®) and is illustrated as not being selected as a preferred category.

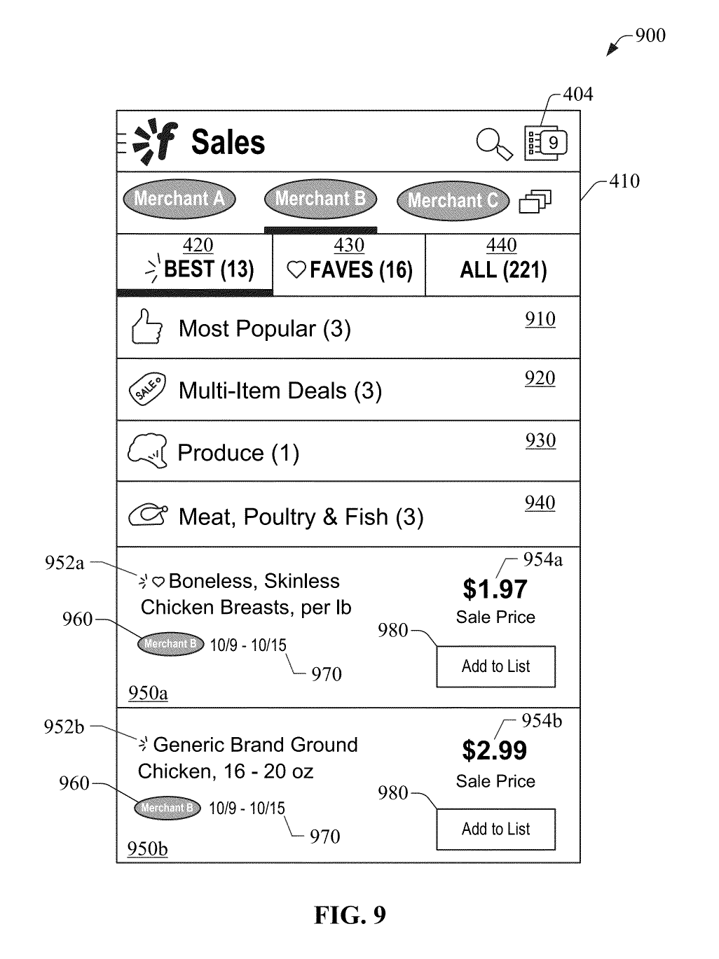

In an example scenario in which the consumption device is embodied in or includes an end-user device (e.g., mobile or otherwise), incentive information (e.g., sale information) and/or matchup content for a specific product or type of product can be configured via the interface unit 158. FIG. 9 illustrates another example of a user interface that permits access to incentive information from the incentive/benefit storage 144. For instance, the user interface shown in FIG. 9 presents an example of a view of incentive information (e.g., most incentivized products (also referred to as “best deals” or “best”) in accordance with one or more aspects of the disclosure. “Best” views can be presented in various categories, which themselves can provide respective views. Similarly to other user interfaces of this disclosure, the example user interface 900 shown in FIG. 9 includes the banner 410, and indicia 420, 430, and 440. As described herein, actuation of indicia 420 can cause the consumption device that renders the user interface 900 to obtain incentive information representative of the best incentives for such a merchant (e.g., “Merchant B”) that can be selected via actuation of indicia 410.

The example user interface 900 also can include indicia 910, which is actionable and, in response to actuation, can cause the consumption device that renders the user interface 900 to access incentive information indicative or representative of incentives for certain categories of goods, products, and/or services. As an example, indicia 910 is labeled “Most Popular,” which conveys that the incentive information (e.g., sales information) obtained via actuation of the indicia 910 can cause the consumption device to obtain and render incentive information indicative of most popular incentives, second most popular incentives, or the like. In addition, the indicia 910 also can include markings (e.g., “(3)”) indicative of the number of incentives in the category represented by the indicia 910. In addition, the example user interface 900 can include indicia 920 representative of best incentives for multiple items. As illustrated, the indicia 920 can include markings (e.g., “(3)”) indicative of the number of incentives in the category represented by the indicia 920. Further, the example user interface 900 can include indicia 930, which is actionable and, in response to actuation can cause the consumption device to obtain and render available best incentives associated with the category represented by the indicia 930. For the sake of illustration, the indicia 930 is labeled “Produce” and includes markings (e.g., “(1)”) indicative of the number of available best incentives in the produce category.

The example user interface 900 can include other actionable indicia representative of other categories for which best incentives are available. As an illustration, the example interface 900 can include indicia 940 representative of the “Meat, Poultry, and Fish” category. In response to actuation, the indicia 940 can cause the consumption device that renders the interface 900 to present one or more of the best incentives in the category represented by the indicia 940. The indicia 940 also can include markings indicative of the number of available best incentives in the “Meat, Poultry, and Fish” category. As illustrated, actuation of the indicia 940 can cause the rendering of incentive information for two items, where the incentive information may be presented in two banners 950a and 950b, each including indicia representative of the incentive information. It should be appreciated that, in certain embodiments, more or less than two incentives may be rendered at a time based at least on the display space available for presenting such incentives. In certain embodiments, the indicia rendered within the region spanned by the banners 950a and 950b can be updated in response to interaction with a portion of such a region. For instance, the indicia can be scrolled up or down in response to a screen swipe or a screen tap. Similarly, the indicia can be scrolled sideways in response to a screen swipe. In the illustrated example, the banners 950a and 950b include respective indicia 952a and 952b, each representing or otherwise indicating the item associated with the incentive (e.g., the item on sale) in the category represented by the indicia 940. The banners 950a and 950b also include respective indicia 954a and 954b, each representing or otherwise indicating a monetary value (e.g., a sale price) of the respective incentive. In addition, the banners 950a and 950b also include respective indicia 960 representative or otherwise indicative of a merchant that provides the incentive. Further, each of the banners 950a and 950b can include indicia 970 indicative of a period (e.g., a week) during which the incentive is redeemable or otherwise active; and indicia 980 (labeled “Add to List” for the sake of illustration), which can be actionable and, in response to actuation, can cause the consumption device to supply or retain the incentive information that is being rendered.

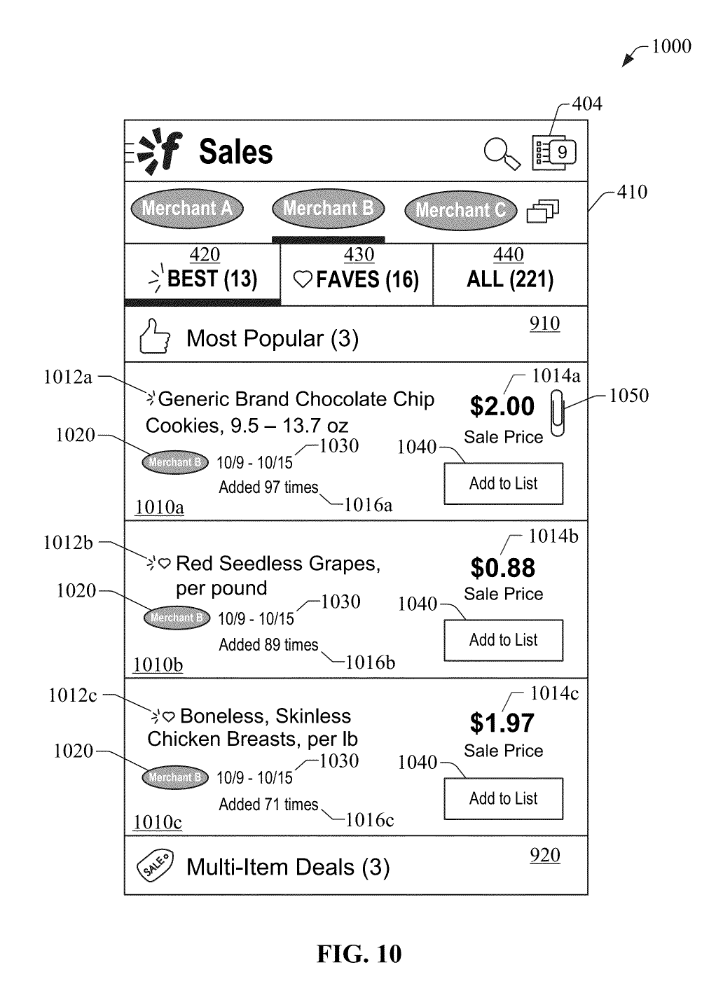

FIG. 10 illustrates an example of a user interface 1000 that a consumption device (e.g., a smartphone, tablet computer, or desktop computer) can render in response to actuation of the indicia 910 described herein in accordance with one or more aspects described herein. As illustrated, three banners 1010a, 1010b, and 1010c can be rendered, each of the banners conveying indicia representative of three incentives included in the “Most Popular” category. Each of the banners 1010a, 1010b, and 1010c includes indicia representative of incentive information. It should be appreciated that, in certain embodiments, more or less than three incentives may be rendered at a time based at least on the real state available for presenting such incentives. In scenarios in which more than three incentives are available, the indicia rendered within the region spanned by the banners 1010a, 1010b, and 1010c can be updated in response to interaction with a portion of such a region. For instance, the indicia can be scrolled up or down in response to a screen swipe or a screen tap, and subsequently or concurrently updated. Similarly, the indicia can be scrolled sideways in response to a screen swipe. In the illustrated example, the banners 1010a, 1010b, and 1010c include respective indicia 1012a, 1012b, and 1012c, each representing or otherwise indicating the item associated with the incentive (e.g., the item on sale) in the category represented by the indicia 910. The banners 1010a, 1010b, and 1010c also include respective indicia 1014a, 1014b, and 1014c, each representing or otherwise indicating a monetary value (e.g., a sale price) of its respective incentive. In addition, the banners 1010a, 1010b, and 1010c also include respective indicia 1020 representative or otherwise indicative of a merchant that provides the incentive. Further, each of the banners 1010a, 1010b, and 1010c can include indicia 1030 indicative of a period (e.g., a week) during which the incentive is redeemable or otherwise active; and indicia 1040 (labeled “Add to List” for the sake of illustration), which can be actionable and, in response to actuation, can cause the consumption device to supply or retain the incentive information that is being rendered.

As described herein, indicia 910 can represent a “Most Popular” category. As such, each of the banners 1010a, 1010b, and 1010c can include indicia 1016a, 1016b, and 1016c representing or otherwise indicating a number of times that the respective incentives have been selected by consumption devices functionally coupled to the incentive/benefit store 144. It should be appreciated that such a number represents a metric of popularity of the incentive. In addition, one or more of the incentives associated with the category represented by the indicia 910 can have respective matchup content associated therewith, which can be represented with specific indicia. For instance, the incentive represented by the banner 1010a can include indicia 1050, which is representative of availability of matchup content and can be actionable. Actuation of the indicia 1050 can cause the consumption device that renders the example user interface to obtain and render the matchup content associated with the incentive represented by the banner 1010a and indicia therein. Matchup content that can be rendered is illustrated in FIG. 5.

In addition, in an example scenario in which the consumption device embodies or comprises an injection device (e.g., a smartphone, a tablet computer, or a desktop computer) of the injection device(s) 110, the interface unit 158 can permit configuration of a predetermined group of retailers or service providers for which matchup content is to be delivered to the consumption device. As described herein, at least a portion of the matchup content can be delivered in accordance with a distribution agreement.

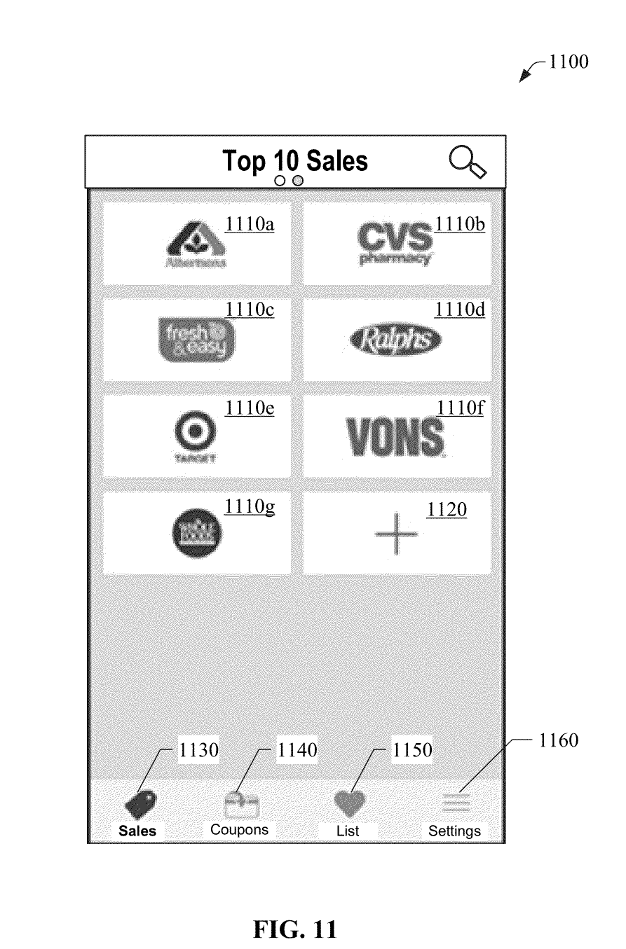

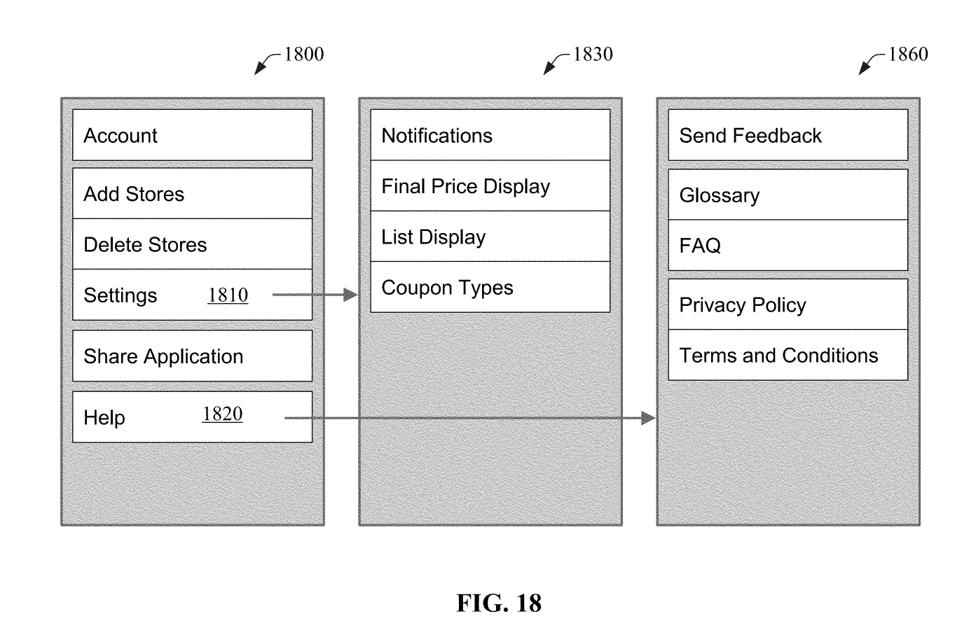

FIG. 11 presents an example of a user interface 1100 that permits accessing predetermined incentives (e.g., deals, coupons, and/or matchups) in accordance with one or more embodiments of the disclosure. As illustrated, the predetermined incentives can include a group of most incentivized items (e.g., goods or services), which also may be referred to as best incentives (e.g., top ten sales). The illustrated user interface 1100 can present several indicia 1110a-1110g, each associated with a specific merchant (e.g., Merchant A, Merchant B, and so forth) and actionable or otherwise selectable. While specific merchants are illustrated in the user interface 1100, it should be appreciated that the disclosure is not so limited and the number and/or type of merchants (e.g., department store, grocery store, service provider, and so forth) represented or otherwise included in the user interface 1100 can be configured in accordance with aspects of this disclosure (see, e.g., FIG. 18). For instance, the user interface 1100 includes actionable indicia 1120 that, in response to actuation, can cause the device that presents the user interface 1100 to present another interface that can permit configuring one or more additional merchants to be presented in the user interface 1100.

As illustrated, the user interface 1100 also includes actionable indicia 1130, 1140, 1150, and 1160 that, in response to actuation, can cause the device that presents the user interface 1100 to present other content (actionable or otherwise) and/or provide specific functionality. Such a device can be one of the consumption device(s) 150, and can be embodied in or can constitute a smartphone, a table computer, other type of mobile computing device, a desktop computer, other type of tethered computing device, or the like.

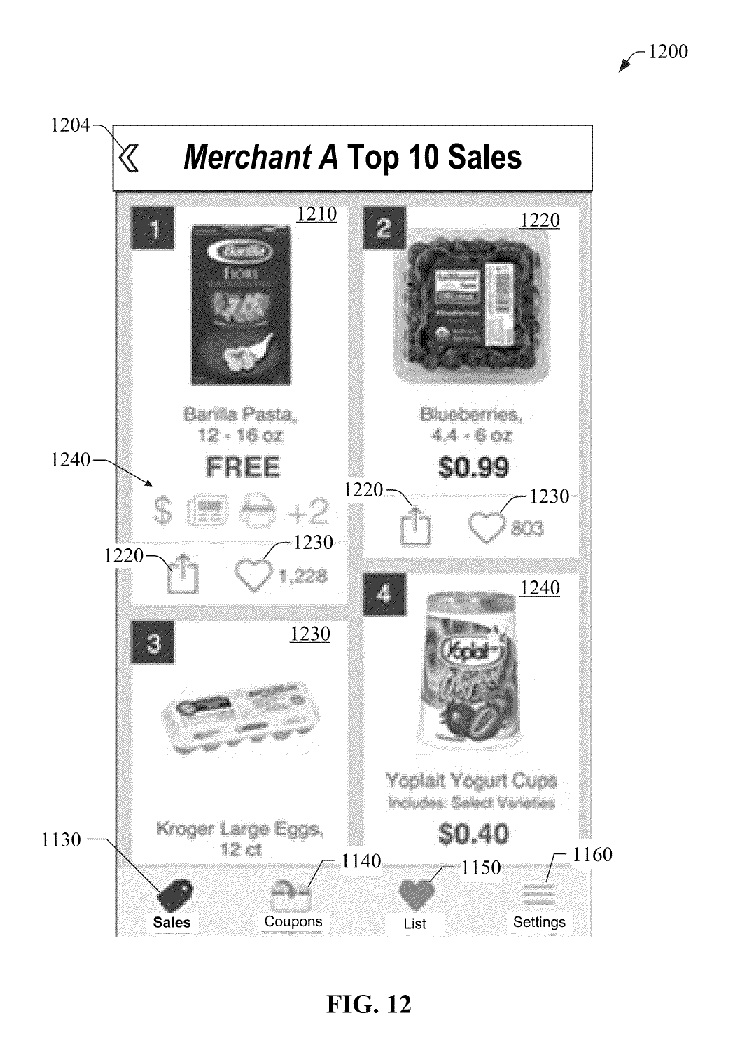

FIG. 12 presents an example of a user interface 1200 that conveys predetermined incentives in response to actuation or selection of one of the indicia 1110a-1110g. As such, the user interface 1200 can present incentives (such as deals) for a selected merchant. The presented incentives can correspond to a specific group of best incentives (e.g., top ten sales) for the merchant. As described herein, indicia can convey the incentives. More specifically, in the user interface 1200, indicia 1210, 1220, 1230 and 1240 can convey or otherwise represent the incentives. It should be appreciated that number of incentives that can be presented in the user interface 1200 can be determined by the real estate (e.g., screen size) available to the device that presents the user interface 1200. Accordingly, more or less than four incentives can be presented on the user interface 1200. In addition, the content or other type of information presented in the user interface 1200 can be refreshed by interacting with the user interface. For instance, interaction with the consumption device the presents the user interface 1200 can permit scrolling down or up, and/or scrolling sideways the information presented in the user interface 1200. In addition, the indicia that conveys the content or the other type of information can be resized by interacting with the consumption device, e.g., a two or more pressure points can be applied to a touch screen of the consumption device, and can be moved while in contact with the screen in order to reconfigure the size of the indicia and thus augment the amount of information presented in the user interface 1200. Accordingly, more or less than four incentives can be presented in the user interface 1200. As described herein, each of the indicia 1210, 1220, 1230, and 1240 can include, for example, a description of the incentivized good, a price for the incentivized good, and/or available matchup incentive(s) (e.g., coupons applicable to the incentive good). Other type of information, such as a period during which the incentive is effective, also can be conveyed by each of such indicia. In addition, each of the indicia 1210, 1220, 1230, and 1240 can include actionable indicia 1220 that in response to actuation can cause the consumption device that presents the user interface 1200 to present a messaging interface that can permit transmitting the incentive to a remote device (e.g., another consumption device or other type of computing device). In certain implementations, the messaging interface can be embodied in a text messaging interface, an email interface, or the like, and can be presented as a pop-up window or a take-over interface, or in any other format suitable for presentation of hyperlinks, forms, content, and/or media. In certain embodiments, the presentation of the messaging interface can be animated. Further, each of the indicia 1210, 1220, 1230, and 1240 also can include actionable indicia 1230 that in response to actuation can cause the consumption device that presents the user interface 1200 to configure the incentive as a favorite incentive and/or as an item to be included in a list (e.g., a shopping list). In certain implementations, the indicia 1230 can provide similar functionality to indicia 1040 described herein. In addition, as illustrated, the user interface 1200 can include indicia 1204 that is actionable and, in response to actuation, can cause the consumption device to cease to present the user interface 1200, and to switch to presenting (e.g., displaying) another user interface, such as a previously displayed user interface (e.g., user interface 1100).

In connection with available matchups, the indicia indicative or representative of an incentive can include indicia indicative of the availability and/or type of matchups that are available. Various types of incentives can be associated with an incentivized product or service to form a matchup or matchup content. Each of the various types of incentives can be identified or otherwise represented with a specific icon or other type of indicia. In one example, incentives in a matchup can include inserts coupons (or inserts) found in printed media (e.g., newspapers or newsletter) from various sources (e.g., Red Plum (RP), SmartSource (SS), and P&G (PG). In another example, incentives in a matchup can include printable coupons which can be accessed via a computing device (e.g., via hyperlink presented in the computing device). This type of incentive can be represented by a printer icon (see indicia 1240). In another example, incentives in a matchup can include electronic coupons (eCoupons) which can be embodied in or can include digital store coupons or coupons provided in digital format via a software application (e.g., a retailer application) and displayed in an electronic device. Digital store coupons can be redeemed directly at the register or a point-of-sale (POS) of a merchant. For example, a digital store coupon can be retained in one or more memory device, such as the incentive/benefit storage 144, and can be associated with a consumer identification (ID) or other type of machine-readable entity. The consumer ID can be embodied in hardware, software, or a combination thereof (e.g., a savings card, a credit card). In addition, information indicative of the consumer ID and/or information indicative or representative of the association between the consumer ID and the digital store coupon also can be retained in one of one or more of the memory devices. At the register or the POS, the consumer ID or other type of machine-readable entity can be scanned or otherwise probed, and information indicative or representative of the consumer can be obtained. The information so obtained can be utilized to redeem a discount or other type of benefit associated with a digital coupon related to the consumer ID.

In certain embodiments, coupons that are accessed via a software application may not affect the accounting at the till, but reconciliation between the till and sales including such coupons can rely on a dedicated account that can receive funds (e.g., electronic fund transfers) in a dedicated account. As such, coupons redeemed via a dedicated software application can be implemented similarly to an electronic rebate. In another example, incentives in a matchup can include “booklet coupons,” such as store coupons or manufacturer coupons that a merchant or manufactured can issue. Such coupons can be found at a merchant's store or in direct mail. In another example, incentives in a matchup can include coupons includes in store sale flyers and/or coupons that are found in weekly advertisement or other type of advertisement from the retailer. In another example, incentives in a matchup can include coupons available in printed magazines. Access to this coupon may include purchase of a subscription to the magazine, which includes the coupons. In another example, incentives in a matchup can include mail-in rebates. In order to access such coupons a form may be completed and mailed to a rebate processing center, and after a certain processing period a refund from the purchased can be received in the mail. In another example, incentives in a matchup can include store or manufacturer coupons issued at check-out after completion of a purchase or other type of transaction. In certain implementations, manufacturers can tier such coupons, with greater incentives for greater expenditure (e.g., greater discounts are achieved by buying more products or services). For instance, one such coupon can include the following incentive: Buy 3 Tide Detergent, Get $2 OFF On Your Next Order. In another example, incentives in a matchup can include “home-mailer coupons,” which can be issued by a merchant (e.g., a grocery chain) and can be mailed to consumers' homes or place of residence.

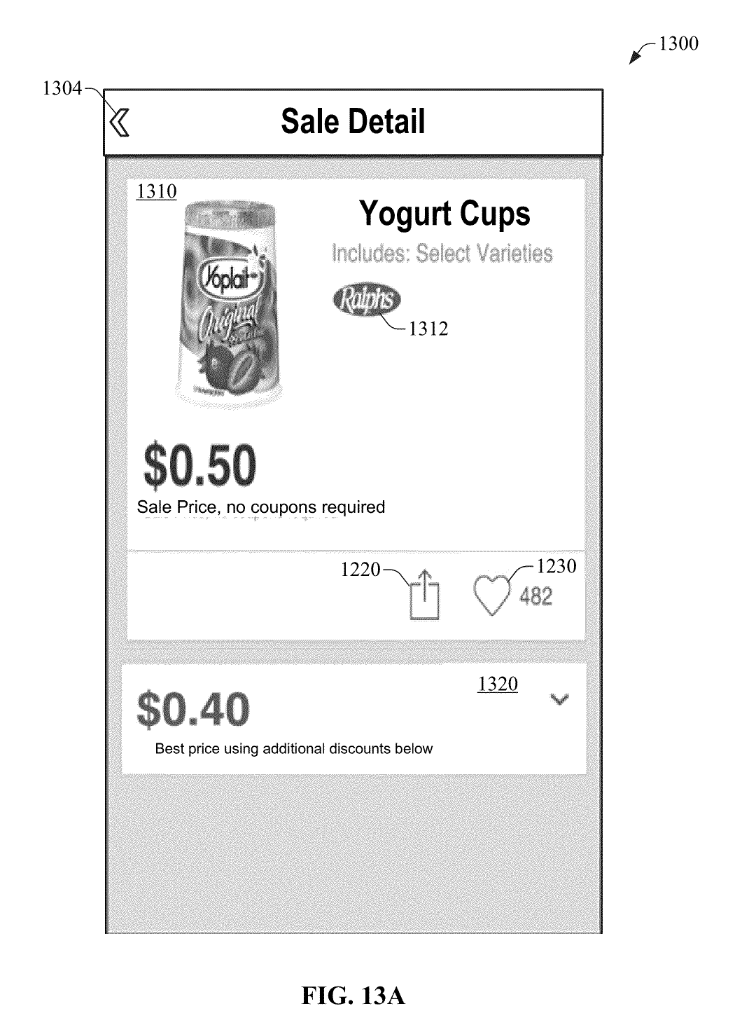

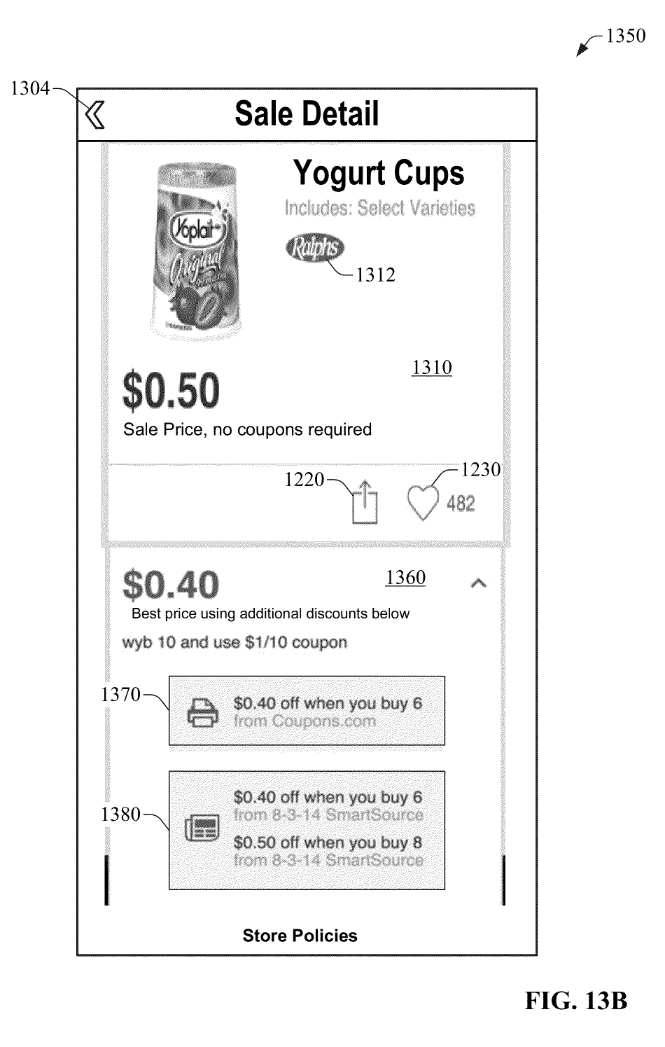

As described herein, the indicia representative or otherwise indicative of an incentive (e.g., a product on sale or other type of deal) can be actionable and, in response to actuation, the consumption device that present such indicia can present an interface that conveys details or other type of information that characterizes the incentive. FIG. 13A presents an example of a user interface 1300 that conveys details of an incentive (e.g., a sale in the top ten sales for a merchant) that can be presented in a consumption device in response to actuation of indicia representative or otherwise indicative of the incentive. As illustrated, the example user interface 1300 can include indicia 1310 that conveys information characterizing the incentive. In one example, the information can include a product description (or listing name); a sale price and/or a full price of the product. The indicia 1310 also can include indicia 1312 indicative or otherwise representative of the merchant (e.g., Merchant A) that provides the incentive. In other examples, the incentive information can include the types of incentives that are available, such as “buy one get one” (B1G1) at a discounted price or free of charge; conditions applicable to the incentive, such as “valid thru Friday;” combinations thereof, or the like.

In addition, the user interface 1300 can include indicia 1320 indicative or otherwise representative of matchup content (e.g., additional discounts) associated with the incentive characterized by the indicia 1310. As illustrated, the indicia 1320 can convey an adjusted sale price for the product associated with the incentive, and/or a monetary benefit associated with matchup content. In certain embodiments, the indicia 1320 can be actionable and, in response to actuation, the consumption device that presents the user interface 1300 can present a user interface conveying details of the matchup content. FIG. 13B presents an example of a user interface that conveys the matchup content associated with the incentive shown in FIG. 13A. As illustrated, the example user interface 1350 includes the indicia 1310, and indicia 1360 conveying information indicative or otherwise representative of the matchup content. The indicia 1360 can include other indicia that can convey available incentives that form the matchup. For example, indicia 1370 can represent printable coupons (represented by a printer icon) and indicia 1380 can represent discounts for multiple purchases via insert coupons (represented by a folded newspaper). It should be appreciated that other incentives can include more or less than two incentives in the associated matchup content.

Similarly to other user interfaces described herein, the user interface 1300 can include indicia 1304 that is actionable and, in response to actuation, can cause a consumption device to cease to present the user interface 1300, and to switch to presenting (e.g., displaying) another user interface, such as a previously displayed user interface (e.g., user interface 1200).

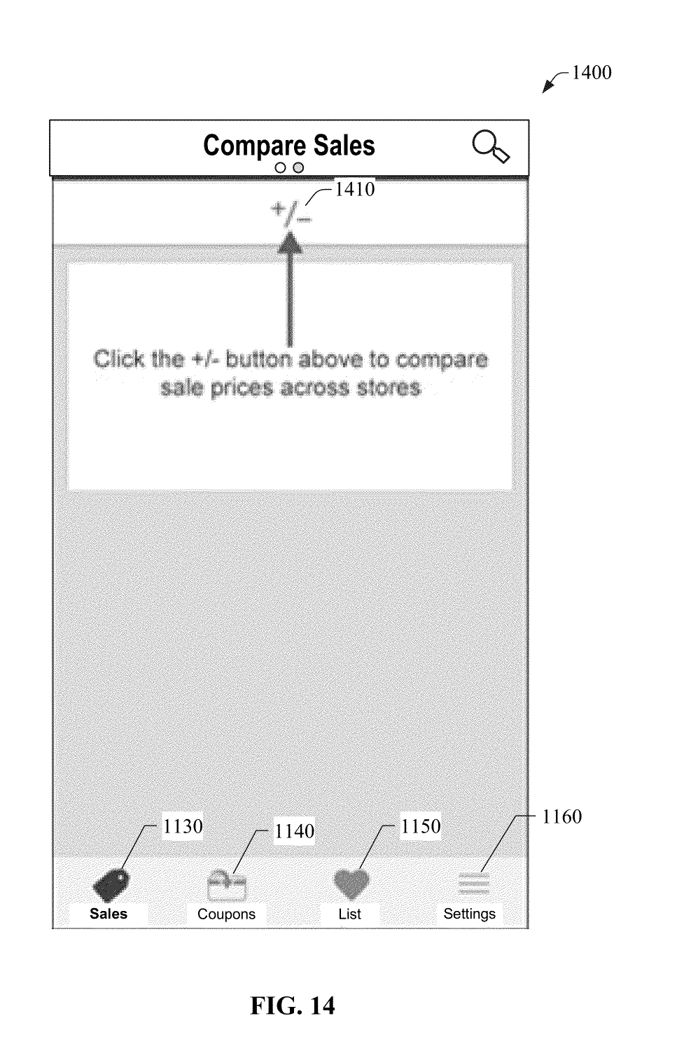

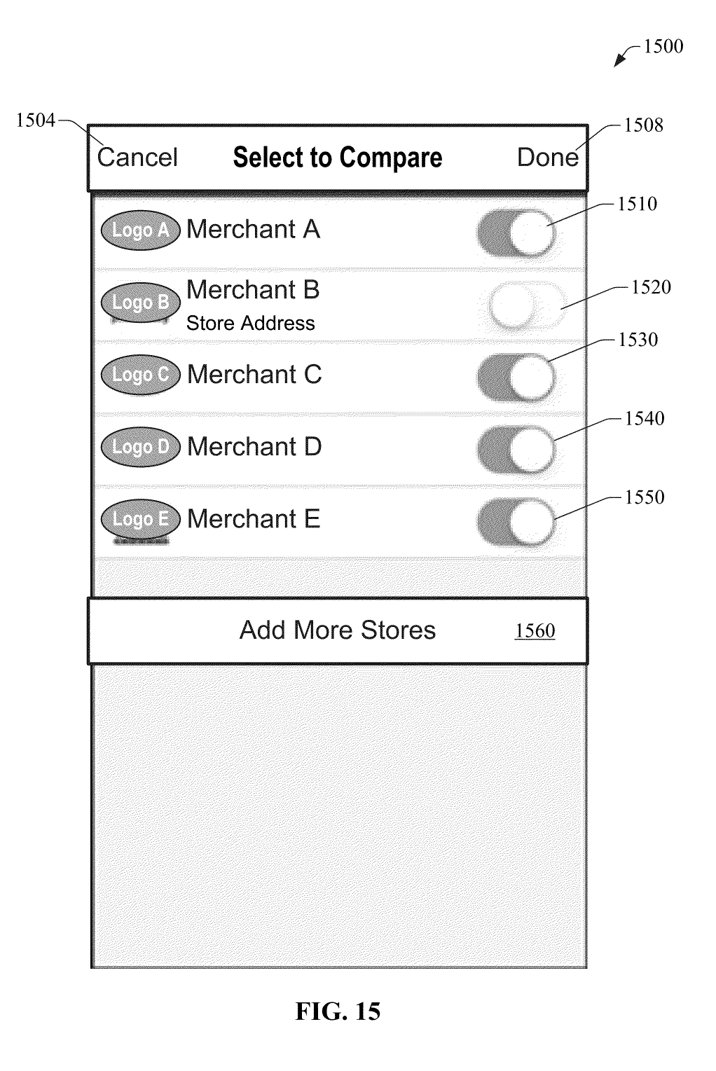

FIG. 14 presents an example of a user interface 1400 that permits accessing another interface to compare incentives in accordance with one or more embodiments of the disclosure. In certain embodiments, the consumption device that presents the user interface 1400 can be cause to present such an interface in response to an interaction between an end-user and the example user interface 1100 in FIG. 11. More specifically, yet not exclusively, a swipe or other type of interaction with a screen that permits visualizing the user interface 1100 can cause the consumption device to present the user interface 1400. The user interface 1400 can include actionable indicia 1410 that in response to actuation can cause the consumption device that presents the user interface 1400 to present the another user interface that can permit configuring specific comparisons of incentives at different merchants. For example, in one embodiment, FIG. 15 presents an example of a user interface 1500 that permits selecting merchants for comparison of incentives amongst the selected merchants in accordance with one or more embodiments of the disclosure.

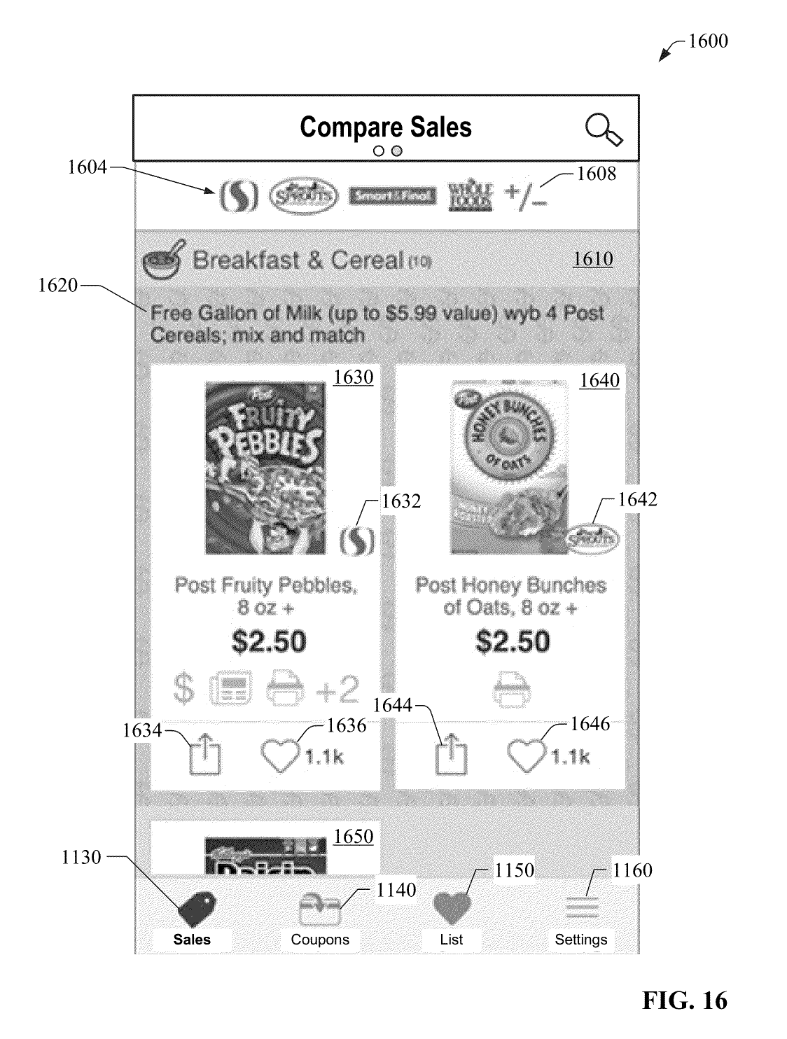

In certain implementations, the user interface 1500 can include actionable indicia that can permit selecting a merchant for inclusion or exclusion in a comparison of incentives (e.g., sales or deals). For example, the user interface 1500 can include indicia 1510, 1520, 1530, 1540, and 1550 that can be actuated to select a merchant for inclusion or select a merchant for exclusion from a comparison. Indicia associated with a merchant included in a comparison can be different from the indicia associated with a merchant excluded from a comparison. In the illustrated example, merchants associated with indicia 1510, 1530, 1540, and 1550 are included in a comparison, whereas the merchant associated with the indicia 1520 is excluded from the comparison. Actuation of each of such indicia can cause the consumption device that presents the user interface 1500 to transmit a notification to one or more of the server(s) 130 to configure the merchant as either included in a comparison or excluded from a comparison. The one or more of the server(s) 130 can receive the notification and configure the merchant accordingly. After configuration is complete, at least one the servers can generate or otherwise access sale comparison between the merchants configured for comparison, and can transmit such information to the consumption device. The consumption device that presents the sale comparison information can present at least a portion of such information in a specific user interface, such as the user interface 1600 shown in FIG. 16.

In addition, with reference to FIG. 15, the user interface 1500 also can include actionable indicia 1560 that, in response to actuation, can cause the consumption device that presents the user interface 1500 to transmit a notification or other type of signaling to one or more of the servers 130 to add one or more merchants (which in the illustrated example are referred to as “stores”) in a pool of merchants available for comparison of incentives. At least one of the server(s) that receives the notification or other type of signaling can configure the one or more merchants as available for comparison of incentives. When one of such merchants is selected for inclusion in a comparison, one or more of the servers can provide incentive information and/or comparison information to the consumption device. In addition or in other embodiments, the user interface 1500 can include indicia (not depicted) that, in response to actuation, can prompt an end-user or other type or source (e.g., a device), to input or otherwise provide recommendation information indicative or representative of a recommendation for a new merchant to be added to the pool of merchants available for comparison. The consumption device that renders the user interface 1500 can receive at least a portion of the recommendation information and can transmit a notification or other type of signaling to a server of the one or more server(s) 130 to include the new merchant in such a pool of merchants. In certain implementations, the notification or other signaling can direct the server to provide incentive information and/or comparison information for the new merchant.

In addition, as illustrated, the user interface 1500 can include actionable indicia 1504 and 1508, represented with the terms “Cancel” and “Done,” respectively, that permit terminating the configuration of merchants for inclusion in or exclusion from a comparison of incentives (e.g., sales of consumer goods). Actuation of the indicia 1504 can reject any selection(s) of merchants for comparison. Actuation of the indicia 1508 can cause the consumption device that presents that user interface 1500 to transmit a notification to a remote server (e.g., one of the server(s) 130) to confirm the selection of a group of two or more merchants for comparison. Such a server can receive the confirmation, or information indicative thereof, and in response, can initiate a comparison between at least two of the group of merchants that have been selected.

FIG. 16 presents an example of a user interface 1600 that conveys a comparison of incentives between merchants in accordance with one or more embodiments of the disclosure. The user interface 1600 includes indicia 1604 indicative or otherwise representative of a group of merchants included in the comparison. Such a group can be selected via a suitable interface, such as example user interface 1500. In addition, the user interface 1600 includes actionable indicia 1608 that, in response to actuation, can cause the consumption device that presents the user interface 1600 to present a user interface (such as user interface 1500) to configure comparisons between merchants. As illustrated, the user interface 1600 also can include indicia 1610 indicative or otherwise representative of a category of incentives (e.g., “breakfast and cereal”) and a number of incentives being compared in such a category (represented with “(10)” in FIG. 16. Indicia 1620 (actionable or otherwise) also can be included in the user interface 1600 in order to convey additional incentive(s) and/or promotional information which may be related to the incentive category conveyed by the indicia 1610. Further, the user interface 1600 can include indicia 1630, 1640, and 1650 (which is shown partially in FIG. 16), each of which can be indicative or otherwise representative of an incentive generated or otherwise obtained via a comparison. As illustrated with indicia 1630 and 1640, each of the indicia indicative of otherwise representative of an incentive included in a comparison can include indicia indicative or otherwise representative of a respective merchant (e.g., Merchant A, Merchant B, and so forth), as shown by indicia 1632 and 1642. As further illustrated with indicia 1630 and 1640, each of the indicia indicative of otherwise representative of an incentive included in a comparison can include actionable indicia (e.g., indicia 1634 and 1644) that in response to actuation, cause the consumption device that presents the example user interface 1600 to provide (e.g., display) a messaging interface in accordance with aspects described herein in connection with indicia 1220. As still further llustrated with indicia 1630 and 1640, each of the indicia indicative of otherwise representative of an incentive included in a comparison can include actionable indicia (e.g., indicia 1634 and 1644) that in response to actuation, cause the consumption device that presents the example user interface 1600 to include and/or to record or cause to record the incentive as a favorite incentive in a similar manner as described herein in connection with indicia 1230. It should be appreciated that more or less than two item categories may be presented at a time based at least on the display space available for displaying the indicia representative of the item categories. It should further be appreciated that the user interface 1600 can present other indicia representative of other incentives in response to interaction with the user interface 1600, e.g., scrolling up or down the content presented in the user interface 1600.

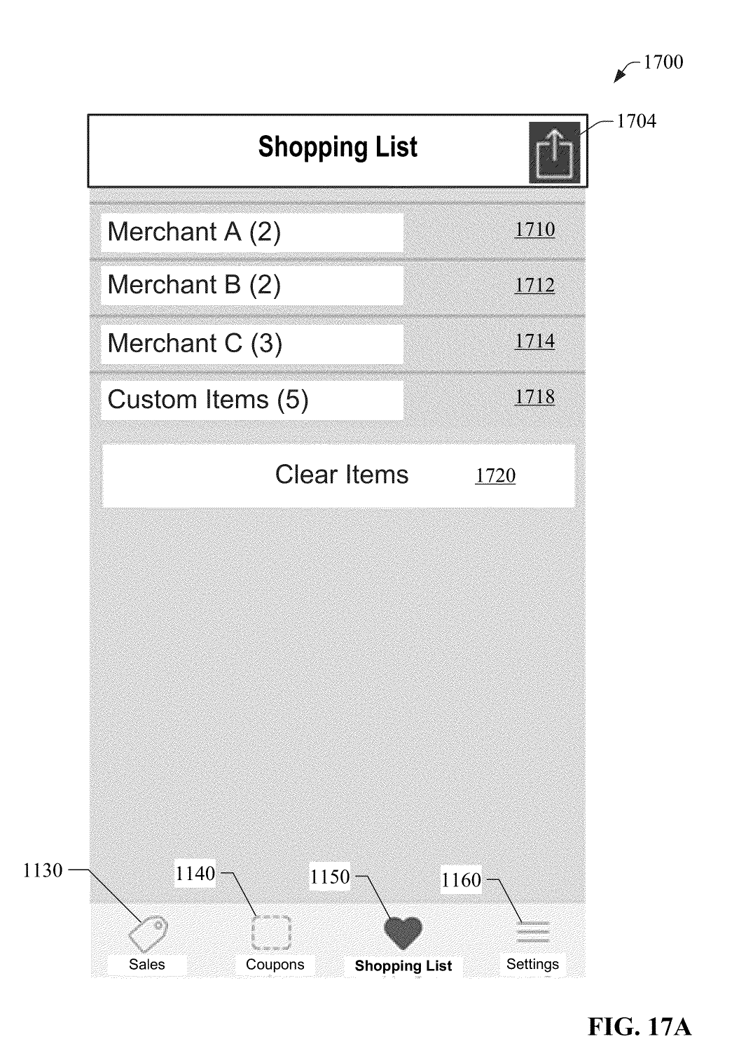

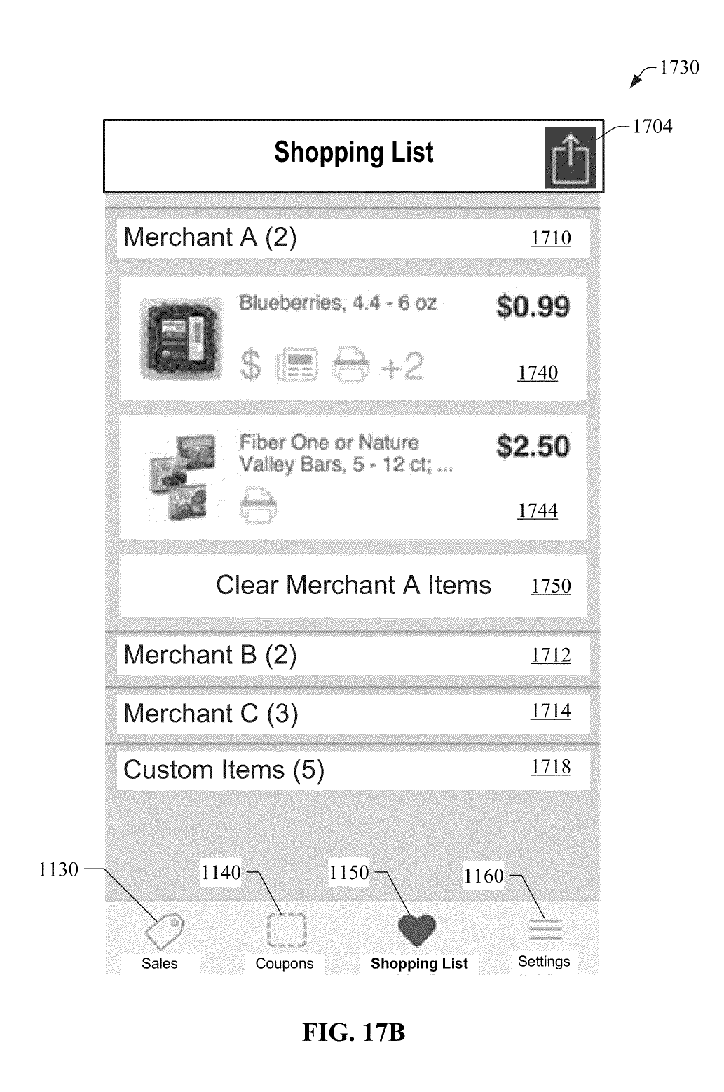

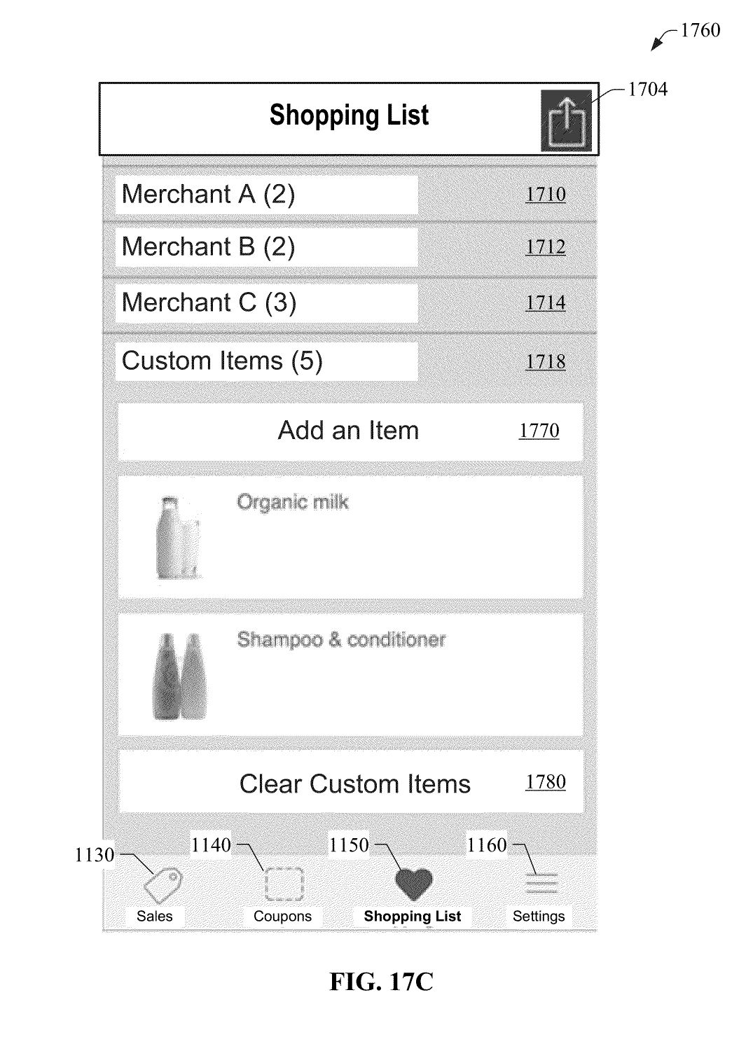

As described herein, a consumption device can present a user interface, such as interface 1100 shown in FIG. 11 that includes actionable indicia that, in response to actuation, can cause the consumption device to present certain incentive information or other type of information related to merchants and/or incentivized products or services (e.g., products on sale, services on sale, coupons and/or other type of discounts for products and/or services, combinations thereof, or the like). In certain embodiments, actuation of indicia such actionable indicia 1150 (including the markings “List” for the sake of illustration) can cause the consumption device to present a user interface that permits accessing and/or configuring a customized list, such as a list of desired good or services (e.g., a shopping list or list of favorite items). FIG. 17A presents one example of such a user interface. The illustrated user interface 1700 can include indicia 1710, 1712, and 1714, each being indicative or otherwise representative of a merchant that provides or otherwise carries one or more desired items. In the example user interface 1700, the number of desired items can be indicated with an Arabic numeral in parenthesis. In addition, in one embodiment, the example user interface 1700 can include actionable indicia 1720 that in response to actuation can cause the consumption device to present another user interface that can permit removing one or more desired items. In other implementations, actuation of the indicia 1720 can cause the consumption device to remove at least one of the desired item(s) locally, where the at least one desired item may be removed from an information structure (e.g., a list, a database, a record, or the like) indicative or otherwise representative of the list of desired items (e.g., a shopping list). In addition or in other implementations, the consumption device can transmit a notification or other type of signaling to one or more of the server(s) 130 in order to convey that one or more items have been removed from a list of desired items (e.g., a shopping list) and/or to suspend communication of incentive information associated with such items. In implementations in which a list of desired items is retained remotely, actuation of the actionable indicia 1720 can cause the consumption device to transmit or otherwise communicate a directive or other type of signaling to at least one of the server(s) 130 to remove one or more (e.g., some or all) items from such a list. In addition, such a directive or other type of signaling can cause the at least one server of the server(s) 130 to suspend of incentive information associated with the removed item(s).

The user interface 1700 also can include actionable indicia 1704 that, in response to actuation, can cause the consumption device that presents the user interface 1700 to present a messaging interface that can permit transmitting the incentive to a remote device (e.g., another consumption device or other type of computing device). In certain implementations, the messaging interface can be embodied in a text messaging interface, an email interface, or the like, and can be presented as a pop-up window, a take-over interface, or any other type of format suitable for presentation of hyperlinks, forms, content and/or media at the consumption device. In certain embodiments, the presentation of the messaging interface can be animated.

In one embodiment, actuation of the indicia representative of a merchant in the user interface 1700 can cause the consumption device to present another user interface conveying information indicative of the desired items carries by the merchant. For instance, actuation of the indicia 1710 can cause the consumption device to present the example user interface 1730 as shown in FIG. 17B. The user interface 1730 can include indicia 1740 and 1744 indicative or otherwise representative of the incentives associated with the desired items for the merchant indicated by the indicia 1710. It should be appreciated that the user interface 1730 is not limited to having indicia 1740 and 1744, and that more or less than two indicia may be presented based at least on the consumption device's display space available for presenting indicia associated with incentivized items. Each of the indicia 1740 and 1744, or any other indicia representative of incentive(s) in a list, can convey numerous types of information that characterize the desired item. For example, such information can include one or more of an image representative of the item; item type; an item description; item sale price; available matchup(s); a combination thereof; or the like. In addition, the user interface 1730 can include actionable indicia 1750 that can cause the consumption device that presents the user interface 1730 to remove or otherwise clear at least one (e.g., one, some, or all) of the shown items from the desired list. To at least such an end, in certain embodiments, the consumption device can remove the items locally at the consumption device, where the items may be removed from an information structure (e.g., a list, a database, a record, or the like) indicative or otherwise representative of the list of desired items. In addition or in other embodiments, the consumption device can transmit a notification or other type of signaling to indicate to one or more of the server(s) 130 that the items have been removed from a list of desired items (e.g., a shopping list) and/or to suspend communication of incentive information associated with such items. As described herein, in certain embodiments, the list of desired items can be retained remotely and actuation of the actionable indicia 1720 can cause the consumption device to transmit or otherwise communicate a directive or other type of signaling to at least one of the server(s) 130 to remove one or more items from such a list. In addition, such a directive or other type of signaling can cause the at least one server of the server(s) 130 to suspend of incentive information associated with the removed item(s).

In addition, in certain embodiments, actuation of indicia 1718 in the user interface 1700 can cause the consumption device that presents the user interface 1700 to present another user interface that can permit adding or removing custom item(s) from a list of desired items. As an illustration, FIG. 17C presents an example of a user interface 1760 that permits managing a lists of desired items (e.g., a shopping list) or other type of list (e.g., a list of favorite items) in accordance with one or more embodiments of the disclosure. The user interface 1760 can include actionable indicia 1770 that in response to actuation can cause the consumption device to add a custom item to a list of desired items, and indicia 1780 that can cause the consumption device to remove at least one (e.g., one, some, or all) custom item from the list of desired items (e.g., a shopping list, a list of favorites, or other type of customized list). To at least such an end, in certain embodiments, the consumption device can subscribe to a service provided by one or more of the server(s) 130 in order to receive information indicative of incentives related to a custom item that is added to a list of desired items or any other type of lists. Similarly, the consumption device can unsubscribe from such a service, and thus suspend reception of incentive information associated with the custom item that is removed from a list of desired items.

As described herein, a consumption device (e.g., one of consumption device(s) 150) can receive or otherwise access selection information representative or otherwise indicative of selection of an item from inclusion in a customized list (such as a shopping list or a favorite list). In certain embodiments, the consumption device can collect the selected information and can generate or update a customized list locally retained in the consumption device. In addition the consumption device can transmit at least a portion of the customized list one or more of the server(s) 130. In other embodiments in which the customized list is retained remotely (e.g., in the network repository 140), the consumption device (e.g., a smartphone, a tablet computer, or a desktop computer) can transmit at least a portion of the selection information to one or more servers of the server(s) 130. The one or more servers can generate or update the customized list based on the received selection information. Regardless of the manner in which a server of the server(s) 130 obtains or otherwise access (e.g., receives) a customized list associated with a consumption device, the server can provide an additional or alternative list that can be optimized based at least on the various incentives (coupons, discounts, or the like) available for the item(s) included in the customized list. To that end, in one example, a composition unit 138 associated with the server can identify merchants and/or merchant stores that provide one or more of the items in the customized list at a satisfactory (e.g., optimal, nearly optimal, etc.) price, which can include incentives an item of the one or more items. In addition or in other embodiments, such a composition unit 138 can identify a comparable items having respective satisfactory prices regardless of merchant or merchant store, and thus, the additional or alternative list can provide greater incentives and/or benefits to an end-user of the consumption device. The server that determines the additional or alternative list, which may be referred to as an “optimized list,” can transmit information indicative of the optimized list to the consumption device. In certain embodiments, a consumption device can receive input information that permit configuring the generation of an optimized list. For instance, the input information can convey a specific merchant for which the optimized list is to be produced. In addition or in the alternative, the input information can convey that the optimized list is to be produced irrespective of the merchant and/or merchant store that provides a satisfactory price (e.g., sales price or best price). Further or as another alternative, the input information can specify a selection of group of merchants that are to be included in the identification of items for inclusion in an optimized list.

Other types of operations can be implemented via a consumption device in order to configure the incentive information, including matchup content, that can be received at the consumption device. FIG. 18 presents example of user interfaces that permit configuring the access to incentives and/or matchup content, and accessing support functionality. A consumption device that a user interface that include the actionable indicia 1160 can present the user interface 1800 in response to actuation or otherwise selection of the indicia 1160. As illustrated the user interface 1800 can include various indicia that can permit addition of merchants (referred to “stores” in FIG. 18) and removal or merchants, configuration of setting related to incentive information and matchup content, sharing of a software module (or “application”) or a link to a software module that provides at least some of the functionality described in this disclosure, and access to customer service. More specifically, in one example, actuation of indicia 1810 can cause the consumption device 1810 to present the example user interface 1830 that can convey various actionable indicia that, when actuated, can permit the consumption device to receive configuration information specifying one or more of type of notifications desired or permitted to be received at the consumption device; format or type of final price display (e.g., price after sales and matchup content is accounted for); format of indicia associated with lists of items (or incentives); types of incentives, such as coupons, that are desired and/or permitted to be received at the consumption device; or the like. In certain embodiments, configuration information received via the user interface 1830 can be relayed to one or more of the server(s) 130 in order to request specific type of incentive information to be transmitted to the consumption device. In one embodiment, such configuration information can permit subscribing the consumption device to a service that provides incentive information in accordance with the configuration information. In addition, in certain embodiments, the configuration information that specifies formatting features for lists of incentives or other type of lists, sale prices, final prices, and the like, can be retained locally at the consumption device and applied to format such information accordingly.

In one example, actuation of indicia 1820 (which includes the term “help” in the illustrated FIG. 18) can cause the consumption device that renders the user interface 1800 to present the user interface 1860. As illustrated, the example user interface 1860 can include actionable indicia that can cause the consumption device to transmit performance or perceived performance of at least some of the performance described herein; to access a glossary of information related to the functionality described herein; to access a repository of inquiries related to the functionality described herein; to access policies; and/or to access terms and conditions.

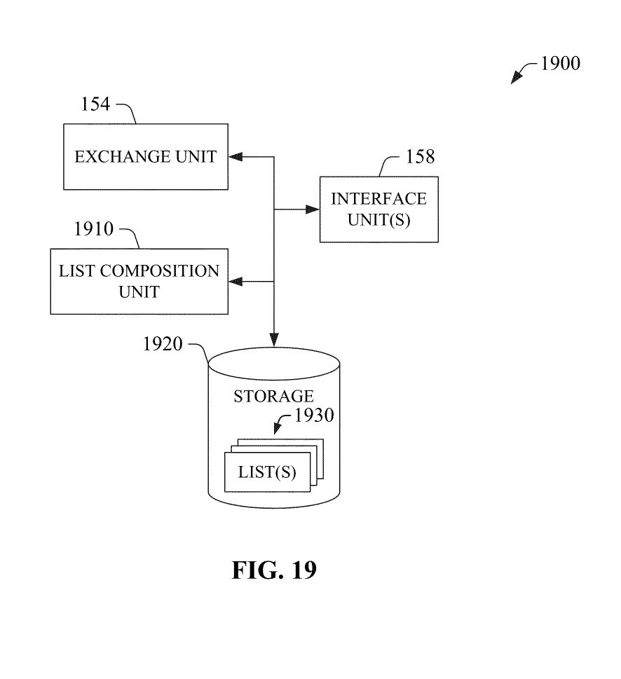

FIG. 19 illustrates an example of a consumption device 1900 of the consumption device(s) 150 that can permit generation of customized lists of products and/or incentivized services based at least in part on a view of the incentive/benefit storage 144 (e.g., specific incentive information, benefit information, and/or matchup information) that is rendered or otherwise presented at the consumption device 1900. To at least such an end, as described herein, at least a portion of the indicia rendered in a view of the incentive/benefit storage 144 can include actionable indicia that in response to actuation thereof or interaction therewith can cause a list composition unit 1910 to generate a record of a deal or other incentive associated with the actionable indicia. The actionable indicia can be embodied in or can include selectable rendered graphical objects (such as actionable indicia 480, 550, 640, 980, and 1040) and can be actuated via a gesture; a touch, such as a screen tap or a screen swipe; a combination thereof; or other forms of interaction with the actionable indicia. More particularly, in one example, an interface unit of the interface unit(s) 158 can receive actuation information indicative of a selection of an incentive to be retained in a list or other information structure. The interface signal or otherwise direct the list composition unit 1910 to generate a record of the incentive information associated with the selected incentive. Accordingly, the list composition unit 1910 can retain the record in at least one of one or more memory elements 1930 (which may be referred to as list(s) 1930) in storage 1920. A collection of one or more records so created can form a list, such as a shopping list, to be utilized by an end-user associated with the consumption device 1900.

In certain implementations, a customized list can embody or can constitute a shopping list that may be created for a specific retailer or a specific store associated with the retailer. For instance, an end-user associated with the consumption device 1900 can create the shopping list via actuation of certain actionable indicia (such as actionable indicia 480, 550, 640, 980, and 1040) and indicating or otherwise conveying the store in which the end-user plans to shop. In one example, one of the interface unit(s) 158 can receive information of the retailer or a specific store thereof, and can tag or otherwise identify with such information the shopping list created by the list composition unit 1910 of the consumption device 1900.

In other implementations, the list composition unit 1910 of the consumption device 1900 of the consumption device(s) 150 can permit generation of a customized list (e.g., a shopping list) of products or services via a comparison between a list of products or services and retailer stores in order to identify one or more satisfactory retailer stores at which to shop. Such satisfactory retailer store(s) can include the best retailer store, the second best retailer store, a combination thereof, or the like. Therefore, in one aspect, the list composition unit 1910 can cross-reference the list of products or services against in-store incentives (e.g., sales) as well as matchup content (such as CPG coupons related to the in-store incentives) in order to maximize savings or achieve any other satisfactory or otherwise desired level of savings. For instance, the list composition unit 1910 can query the incentive/benefit storage 144 for incentives for each of the products and/or services in the list, and can compare incentive information received in response to one or more queries can determine a satisfactory retailer store.

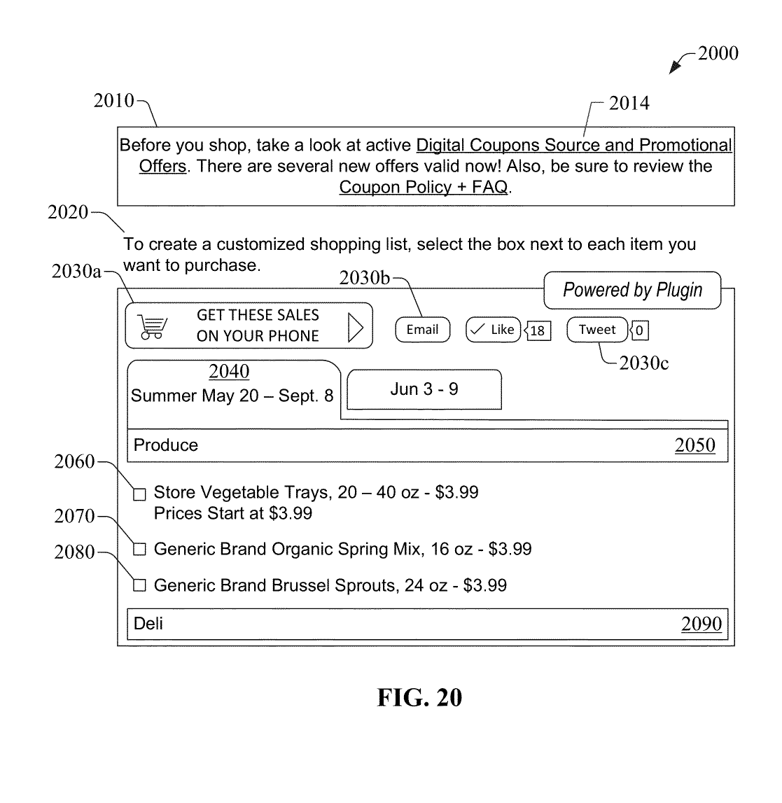

In certain embodiments, user interfaces that can permit consumption of incentive information can be embodied in or can include plug-in components (e.g., blog plug-in components) that can operate in conjunction with web-based interfaces, such as web browsers. FIG. 20 illustrates an example of a user interface 2000 that can be provided via a plug-in component, which can be embodied in at least one of the interface unit(s) 158. The exemplified user interface 2000 can include indicia 2010 having an information structure 2014, such as a hypermedia link, that can permit accessing a source of incentive and/or benefit information from a third party or affiliate. As such, the hypermedia link may be referred to as affiliate link. In addition, the user interface 2000 can include a tab 2040 including indicia 2050 and 2090 representative of respective item categories for which incentives may be available at the incentive/benefit storage 144. While two item categories are illustrated, it should be appreciated that the disclosure is not so limited and more or less than two item categories may be presented concurrently based at least on the display space available for presenting the indicia representative of the item categories. It should further be appreciated that the user interface 2000 can render other indicia representative of other respective item categories in response to interaction with the user interface, e.g., scrolling up or down the content presented in the tab 2040. The tab 2040 can convey a period, or time interval, for which the presented incentives are redeemable or otherwise active.

As illustrated, the user interface 2000 can include selectable indicia 2060, 2070, and 2080 representative of incentives available for an item category. Each of the selectable indicia 2060, 2070, and 2080 can convey the specific item that is incentivized and a specific monetary value of the incentive. In addition, the user interface 2000 can permit generation of a customized list of items (e.g., a shopping list) via selection of one or more of the selectable indicia 2060, 2070, and 2080. Indicia 2020 included in the user interface 2000 can alert an end-user to such a functional feature.

Further, the user interface 2000 can include actionable indicia 2030a, 2030b, and 2030c that can cause the consumption device that implements (e.g., executes) the plug-in component to supply at least a portion of the incentive information that is presented via the user interface 2000. More specifically, in response to actuation, the actionable indicia 2030a can cause the consumption device to communicate the displayed incentive information or a hypermedia link to such information via, for example, a short message service (SMS) or a multimedia message service (MMS) communication. In addition, in response to actuation, the actionable indicia 2030b can cause the consumption device to present an interactive interface (or more informally, a dialog box; not depicted) that can permit or otherwise facilitate communication of the rendered incentive information or a hypermedia link to such information via email. Further, actuation of the actionable indicia 2030c can cause the consumption device to communicate (e.g., publish) the rendered incentive information or a hypermedia link to such information via a social media outlet.

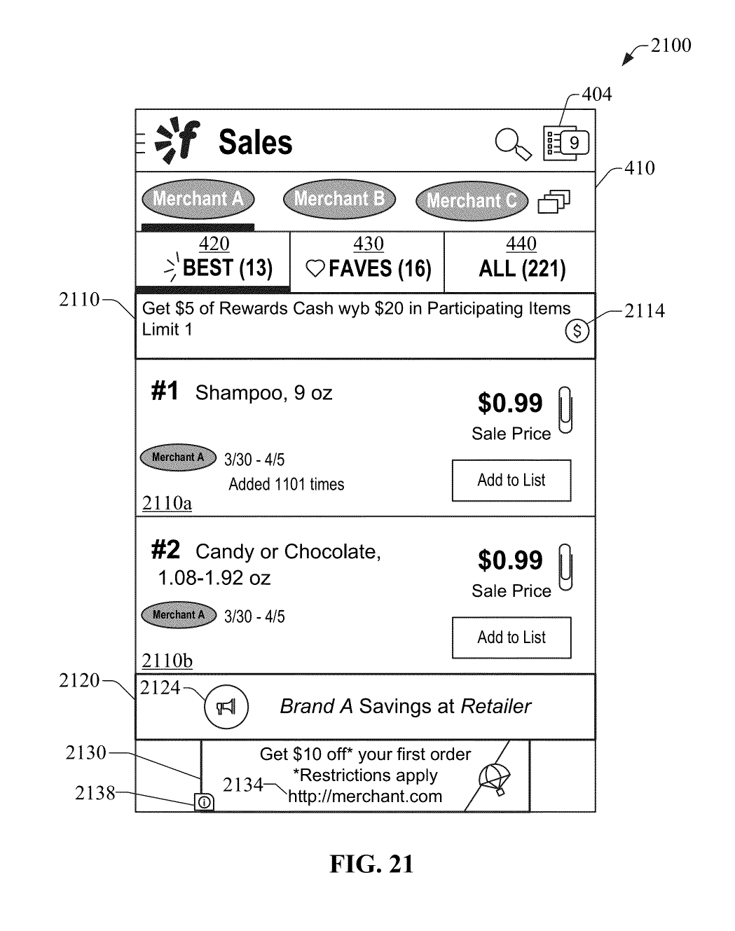

FIG. 21 presents an example user interface 2100 that conveys promotional content in accordance with one or more aspects of the disclosure. For the sake of illustration, the example user interface 2100 presents two deals 2110a and 2110b, each having indicia in accordance with aspects described herein. In addition, the user interface presents banners 2110, 2120, and 2130, each of which conveys promotional content. Banner 2110 includes indicia representative of an amount of reward currency that may be obtained after certain level of expenditure in predetermined items. The reward currency can be embodied in credits of non-monetary currency that may be redeemed at a merchant that offers such credits. The banner 2110 can include actionable indicia 2114 that, in response to actuation, can cause the consumption device that renders the example user interface 2100 to present details of the promotional content associated with the banner 2110. For instance, selection of the indicia 2114 can cause the consumption device to initiate a web browsing session linked to a specific webpage of a website of a merchant that is associated with the rewards promotion.

The banner 2120 can include indicia that conveys that products of a certain brand (represented in FIG. 21 as “Brand A”) may be offered at discounted prices at a specific merchant (represented in FIG. 21 as “Retailer”). Similarly to the banner 2110, the banner 2120 also can include actionable indicia 2124 that, in response to actuation, can cause the consumption device to present incentives associated with the merchant associated with the promotional content conveyed in the banner 2120. In addition or in the alternative, actuation of the actionable indicia 2124 can cause the consumption device to initiate a web browsing session linked to a specific webpage of a website of the merchant that is associated with the discounted products.

The banner 2130 can include indicia that conveys a cash-back promotion for a certain web-based retailer. The banner 2130 also can include indicia 2134 that can cause the consumption device that renders the example user interface 2100 to initiate a web browsing session linked to a landing webpage (e.g., http://merchant.com) or any other webpage of a website of the merchant that is associated with such a promotion. In addition or in the alternative, the banner 2130 can include actionable indicia 2138 that can cause the consumption device to present a description or other details of the cash-back promotion. Such a description or details can be presented in numerous ways, such as a pop-up window or a take-over interface, or in any other presentation format suitable for presentation of hyperlinks, forms, content, and/or media.

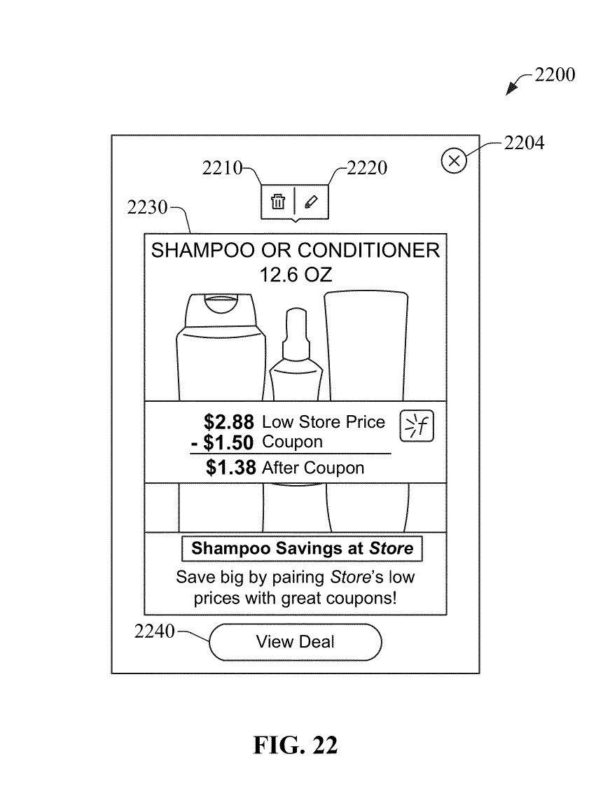

In certain embodiments, promotional content can occupy all or substantially all display space available to present incentive information in a user interface. As such, the promotional content may be referred to as being rendered in a full-screen take-over format. FIG. 22 presents an example of a full-screen take-over presentation of promotional content 2200 in accordance with one or more aspects of the disclosure. The promotional content can include indicia 2230 that conveys a product or products that are promoted and details of the promotion—e.g., discounted retail price, coupons, cash back, reward points or currency, buy-one-get-one (BOGO) promotion, a combination thereof or the like. The promotional content 2200 also can include actionable indicia 2210 that, in response to actuation, can cause the promotional content to be dismissed, e.g., actuation of the indicia 2210 can cause the consumption device that displays the promotional content 2200 to stop displaying the promotional content 2200. Similarly, the promotional content 2200 can include actionable indicia 2204 that, in response to actuation, also can cause the consumption device to dismiss the promotional content 2200. In certain embodiments, one of the actionable indicia 2204 and 2210 can be presented exclusively.

In addition, the promotional content 2200 can include actionable indicia 2220 that, in response to actuation, can permit supplying the promotional content to another device. In one implementation, actuation of the indicia 2220 can cause the consumption device to communicate at least a portion of the promotional content 2200 via, for example, a SMS or an MMS communication. In addition, in response to actuation, the actionable indicia 2220 can cause the consumption device to present an interactive interface (not depicted) that can permit or otherwise facilitate communication of at least the portion of the promotional content 2200 via email. Further, the promotional content 2200 can include actionable indicia 2204 that, in response to actuation, can cause the consumption device to present incentive information including the at least some of the promotional details conveyed by the indicia 2230. The incentive information may be presented in a user interface, such as example user interface 400.

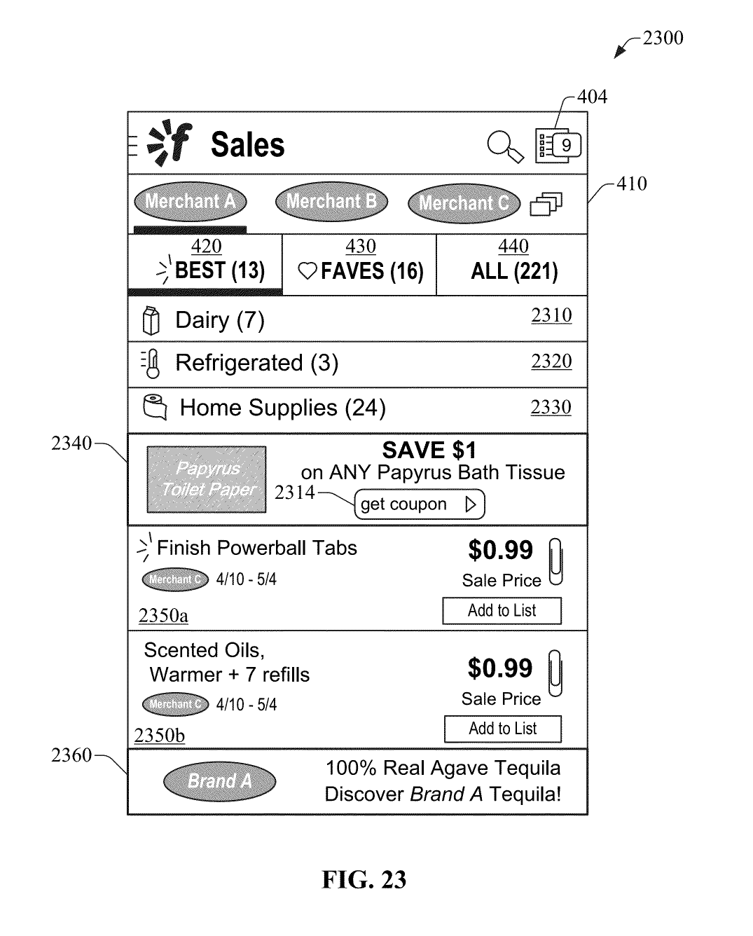

FIG. 23 presents another example of a user interface 2300 that conveys promotional content in accordance with one or more aspects of the disclosure. As illustrated the user interface can include actionable indicia 2310, 2320, and 2330 representative of product categories. Actuation or interaction with the actionable indicia 2330 (labeled as “Home Supplies,” for the sake of illustration) can cause the consumption device (e.g., a tablet computer) that renders the example user interface 2300 to present indicia 2350a and 2350b representative of incentive information for two products within the product category represented by the indicia 2330. In addition, two banners 2340 and 2360 can be rendered, each of the two banners conveying promotional content. Banner 2360 includes indicia that conveys an advertisement for a product (represented with tequila, for the sake of illustration) of a certain brand (represented as “Brand A”). Banner 2340 includes indicia representative of a discount for a brand (represented with “Papyrus,” for the sake of illustration) of a certain product (e.g., bath tissue) within the category represented by the indicia 2330. The banner 2340 also includes actionable indicia 2314 (labeled as “get coupon”) that, in response to actuation, can cause the consumption device to present an interactive interface having a fillable form, with multiple fields, that can permit or otherwise facilitate communication via email of a coupon for the presented discount. In one example, the interactive interface can be associated with an email application, and an end-user can input a recipient name into the fillable form and, optionally, other details, and can submit an email containing information representative of the coupon.

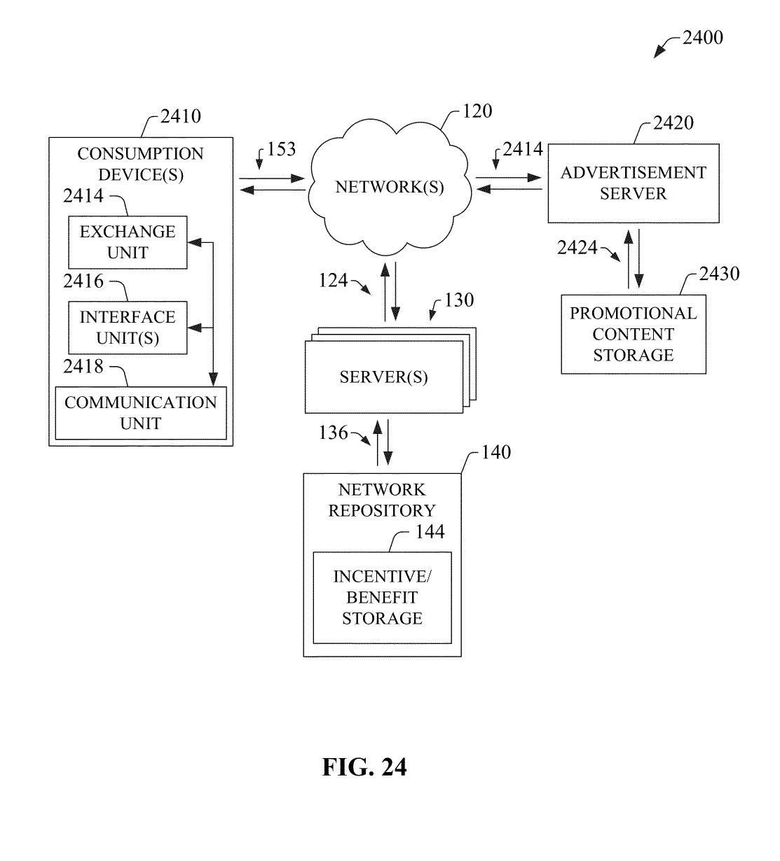

FIG. 24 illustrates an example of an operational environment 2400 that can permit consumption of advertisement in accordance with one or more aspects of the disclosure. A consumption device 2410 can obtain and render incentive information, benefits information, and/or matchup information in accordance with aspects described herein in connection with consumption device(s) 150. As such, in the illustrated example, the consumption device 2410 includes an exchange unit 2414 and one or more interface unit(s) 2416 that can operate in the same manner as the exchange unit 154 and the interface unit(s) 158, respectively. Therefore, the exchange unit 2414 and at least one of the interface unit(s) 2416 can permit the consumption device 2410 to obtain information from the incentive benefit storage 144. For example, the consumption device can provide one or more of the example user interfaces 2100, 2200, or 2300, and can present at least the incentive information presented therein.

In addition, the consumption device 2410 can provide at least the promotional content presented in one or more of the example user interfaces 2100, 2200, or 1500. To at least such an end, in one example, the consumption device 2410 can be functionally coupled to an advertisement server 2420 via at least one of the network(s) 120, the data and signaling communication link(s) 153, and the data and signaling link(s) 2414. The advertisement server 2420 can select or otherwise determine promotional content, such as advertisement and/or other elements of a promotional campaign, to be communicated or otherwise served to the consumption device 2410. The promotional content that can be communicated to the consumption device 2410 can be selected or otherwise determined based on one or more factors. One example factor can include historically consumed incentives and/or preferred product or services (e.g., items in a “favorites” category) for the consumption device 2410. Accordingly, the promotional content can be customized to the consumption device 2410. Another example factor can include a product category (e.g., “Home Supplies” category in example UI 1500) or service category that is selected at the consumption device 2410. As such, the promotional content can be adjusted to a specific end-user experience, as the end-user peruses available incentives. Therefore, the advertisement server 2420 can access historical information and/or configuration information associated with the consumption device 2410 from one or more of the server(s) 130 in order to determine or otherwise select promotional content for the consumption device 2410.

The advertisement server 2420 can obtain the promotional content and/or metadata for the promotional content from a promotional content storage 2430. As an example, the metadata can include, for example, information indicative of a hyperlink or other hypermedia indicative of a merchant and/or merchant store associated with the promotional content. As another example, the metadata can include information that can direct the consumption device 2410 to perform certain actions in response to receiving selection information indicative of interaction with the promotional content rendered at the consumption device 2410. For instance, in connection with indicia 2314 in the example user interface 2300 shown in FIG. 23, the metadata provided by the advertisement server 2420 can cause the consumption device 2410 to render an interactive interface that can permit or otherwise facilitate communication of the promotional content and/or a hypermedia link to such content via email or other type of electronic communication (e.g., SMS, MMS, and/or fax over internet protocol (FoIP)). The consumption device 2410 can include a communication unit 2418 that can permit wireline and/or wireless communication indicative of the promotional content and/or the hypermedia link to the content. While the promotional content storage 2430 is illustrated as being functionally coupled to the advertisement server via data and signaling communication link(s) 2424, it should be appreciated that the promotional content storage may be functionally coupled to the advertisement server 2420 via at least one of the network(s) 120 and suitable data and signaling communication links

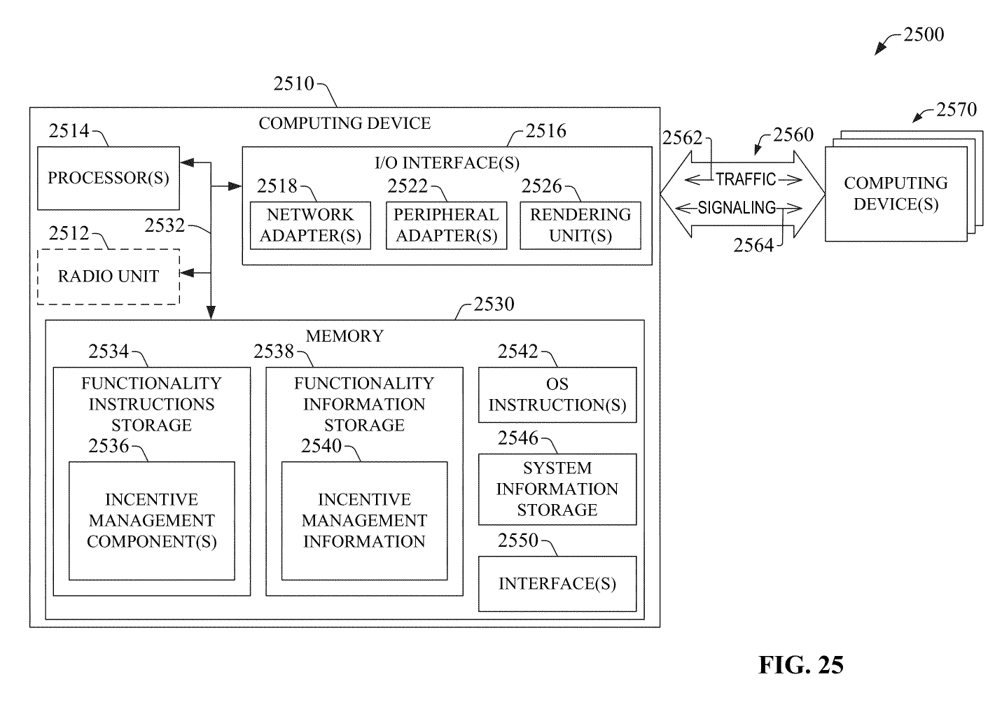

FIG. 25 illustrates a block diagram of an example operational environment 2500 for a crowdsourced incentives and management thereof in accordance with one or more aspects of the disclosure. The example operational environment is merely illustrative and is not intended to suggest or otherwise convey any limitation as to the scope of use or functionality of the operational environment's architecture. In addition, the example operational environment 2500 depicted in FIG. 25 should not be interpreted as having any dependency or requirement relating to any one or combination of components illustrated as part of the operational environment 2500. As illustrated, the operational environment 2500 comprises a computing device 2510 which, in various embodiments, can correspond to the one or more of the injecting device(s) 110, one or more of the consumption device(s) 150, one or more of the server(s) 130, and/or the advertisement server 2420.

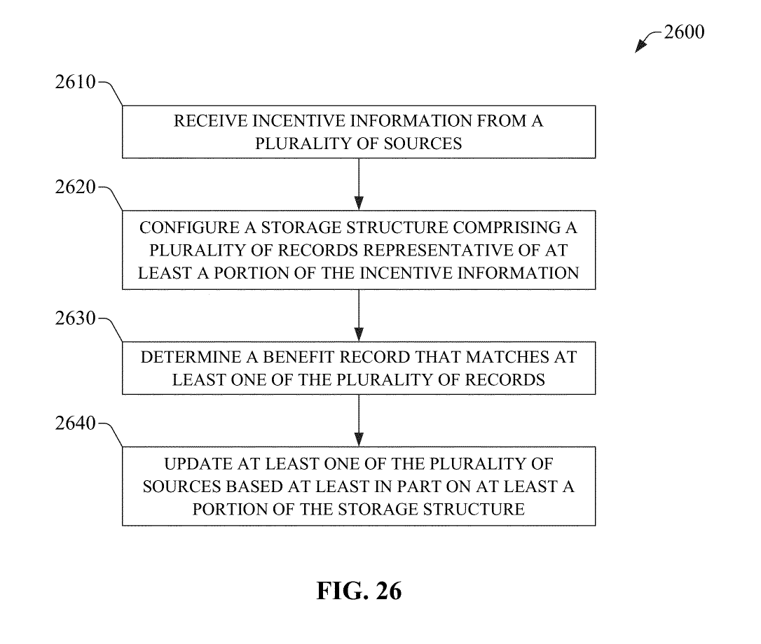

The operational environment 2500 illustrates an example implementation of the various aspects or features of the disclosure in which the processing or execution of operations described in connection with crowdsourced incentives and management thereof disclosed herein can be performed at least in response to execution of one or more software components at the computing device 2510. It should be appreciated that the one or more software components can render the computing device 2510, or any other computing device that contains such components, a particular machine for providing crowdsourced incentives and management thereof as described herein, among other functional purposes. A software component can be embodied in or can comprise one or more computer-accessible instructions, e.g., computer-readable and/or computer-executable instructions. In one scenario, at least a portion of the computer-accessible instructions can embody and/or can be executed to perform at least a part of one or more of the example methods described herein, such as the example methods presented in FIGS. 26-28. For instance, to embody one of such methods, at least a portion of the computer-accessible instructions can be persisted (e.g., stored, made available, or stored and made available) in a non-transitory computer-readable storage medium and executed by a processor. The one or more computer-accessible instructions that embody a software component can be assembled into one or more program modules that can be compiled, linked, and/or executed at the computing device 2510 or other computing devices. Generally, such program modules comprise computer code, routines, programs, objects, components, information structures (e.g., data structures and/or metadata structures), etc., that can perform particular tasks (e.g., one or more operations) in response to execution by one or more processors, which can be integrated into the computing device 2510 or functionally coupled thereto.

The various example embodiments of the disclosure can be operational with numerous other general purpose or special purpose computing system environments or configurations. Examples of well-known computing systems, environments, and/or configurations that can be suitable for implementation of various aspects or features of the disclosure in connection with the cellular-sharing connectivity service described herein can comprise personal computers; server computers; laptop devices; handheld computing devices, such as mobile tablets and/or telephones; wearable computing devices; and multiprocessor systems. Additional examples can include set-top boxes, programmable consumer electronics, network PCs, minicomputers, mainframe computers, blade computers, programmable logic controllers (PLCs), distributed computing environments that comprise any of the above systems or devices, or the like.

As illustrated, the computing device 2510 can comprise one or more processors 2514, one or more input/output (I/O) interfaces 2516, one or more memory devices 2530 (herein referred to generically as memory 2530), and a bus architecture 2532 (also termed bus 2532) that functionally couples various functional elements of the computing device 2510. In certain embodiments, the computing device 2510 can include, optionally, a radio unit 2512. In such embodiments, the computing device 2510 can embody or can constitute a consumption device or an injection device that operates wirelessly. The radio unit 2512 can include one or more antennas and a communication processing unit (not shown in FIG. 25) that can permit wireless communication between the computing device 2510 and another device, such as one of the computing device(s) 2570. The bus 2532 can include at least one of a system bus, a memory bus, an address bus, or a message bus, and can permit exchange of information (data, metadata, and/or signaling) between the processor(s) 2514, the I/O interface(s) 2516, and/or the memory 2530, or respective functional elements therein. In certain scenarios, the bus 2532 in conjunction with one or more internal programming interfaces 2550 (also referred to as interface(s) 2550) can permit such exchange of information. In scenarios in which processor(s) 2514 include multiple processors, the computing device 2510 can utilize parallel computing.

The I/O interface(s) 2516 can permit communication of information between the computing device and an external device, such as another computing device, e.g., a network element or an end-user device. Such communication can include direct communication or indirect communication, such as exchange of information between the computing device 2510 and the external device via a network or elements thereof. As illustrated, the I/O interface(s) 2516 can comprise one or more of network adapter(s) 2518, peripheral adapter(s) 2522, and rendering unit(s) 2526. Such adapter(s) can permit or facilitate connectivity between the external device and one or more of the processor(s) 2514 or the memory 2530. For example, the peripheral adapter(s) 2522 can include a group of ports, which can comprise at least one of parallel ports, serial ports, Ethernet ports, V.35 ports, or X.21 ports, wherein parallel ports can comprise one or more of GPIB ports and/or IEEE-1284 ports, while serial ports can include RS-232 ports, V.11 ports, USB ports, or FireWire or IEEE-1394 ports.

In one aspect, at least one of the network adapter(s) 2518 can functionally couple the computing device 2510 to one or more computing devices 2570 via one or more traffic and signaling communication links 2560 that can permit or facilitate exchange of traffic 2562 and signaling 2564 between the computing device 2510 and the one or more computing devices 2570. Such network coupling provided at least in part by the at least one of the network adapter(s) 2518 can be implemented in a wired environment, a wireless environment, or a combination of both. The information that is communicated by the at least one of the network adapter(s) 2518 can result from implementation of one or more operations in a method of the disclosure. Such output can include any form of visual representation, including, but not limited to, textual, graphical, animation, audio, tactile, or the like. In certain scenarios, each of the computing device(s) 2570 can have substantially the same architecture as the computing device 2510. In addition, or in the alternative, the rendering unit(s) 2526 can include functional elements (e.g., lights, such as light-emitting diodes; a display, such as a LCD, a plasma monitor, a LED monitor, an electrochromic monitor; combinations thereof; or the like) that can permit control of the operation of the computing device 2510, or can permit conveying or revealing the operational conditions of the computing device 2510.

In one aspect, the bus 2532 represents one or more of several possible types of bus structures, including a memory bus or memory controller, a peripheral bus, an accelerated graphics port, and a processor or local bus using any of a variety of bus architectures. As an illustration, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus, a PCI-Express bus, a Personal Computer Memory Card Industry Association (PCMCIA) bus, a Universal Serial Bus (USB), and the like. The bus 2532, and all buses described herein, can be implemented over a wired or wireless network connection, and each of the subsystems, including the processor(s) 2514, the memory 2530 and memory elements therein, and the I/O interface(s) 2516 can be contained within one or more remote computing devices 2570 at physically separate locations, connected through buses of this form, thereby effectively implementing a fully distributed system.

The computing device 2510 can comprise a variety of computer-readable media. Computer-readable media can be any available media (transitory and non-transitory) that can be accessed by a computing device. In one aspect, computer-readable media can comprise non-transitory computer-accessible storage media (, such as non-transitory computer-readable storage media) and communications media. Example computer-readable non-transitory storage media can be any available media that can be accessed by the computing device 2510, and can comprise, for example, both volatile and non-volatile media, and removable and/or non-removable media. In one aspect, the memory 2530 can comprise computer-readable media in the form of volatile memory, such as random access memory (RAM), and/or non-volatile memory, such as read-only memory (ROM).

The memory 2530 can comprise functionality instructions storage 2534 and functionality information storage 2538. The functionality instructions storage 2534 can comprise computer-accessible instructions that, in response to execution by at least one of the processor(s) 2514, can implement one or more of the functionalities of the disclosure. The computer-accessible instructions can embody or can comprise one or more software components illustrated as incentive management component(s) 2536. In one scenario, execution of at least one component of the incentive management component(s) 2536 can implement at least a portion of the functionality described in the present disclosure, and/or one or more of the methods described herein, such as example methods 2600, 2700, and 2800. For instance, such execution can cause a processor that executes the at least one component to carry out a disclosed example method. It should be appreciated that, in one aspect, a processor of the processor(s) 2514 that executes at least one of the incentive management component(s) 2536 can retrieve information from or retain information in a memory element 2540 in the functionality information storage 2538 in order to operate in accordance with the functionality programmed or otherwise configured by the incentive management component(s) 2536. Such information can include at least one of programming code instructions (or code instructions), information structures, or the like. At least one of the one or more interfaces 2550 (e.g., application programming interface(s)) can permit or facilitate communication of information between two or more components within the functionality instructions storage 2534. The information that is communicated by the at least one interface can result from implementation of one or more operations in a method of the disclosure or any other functionality described herein. In certain embodiments, one or more of the functionality instructions storage 2534 and the functionality information storage 2538 can be embodied in or can comprise removable/non-removable, and/or volatile/non-volatile computer storage media.

At least a portion of at least one of the incentive management component(s) 2536 or incentive management information 2540 can program or otherwise configure one or more of the processors 2514 to operate at least in accordance with the functionality described in the present disclosure. In one embodiment, the incentive management component(s) 2536 contained in the functionality instruction(s) storage 2534 can include the exchange unit 154, the exchange unit 134, and/or the composition unit 138. It should be recognized that in such an embodiment, hardware or firmware functional elements of the exchange unit 154, the exchange unit 134, and/or the composition unit 138 can be embodied in suitable components of the computing device 2510. One or more of the processor(s) 2514 can execute at least one of the incentive management component(s) 2536 and can leverage at least a portion of the information in the functionality information storage 2538 in order to provide crowdsourced incentives and management thereof in accordance with one or more aspects of the present disclosure. It should be appreciated that, in certain scenarios, the functionality instructions storage 2534 can embody or can comprise a computer-readable non-transitory storage medium having computer-accessible instructions that, in response to execution, cause at least one processor (e.g., one or more of processor(s) 2514) to perform a group of operations comprising the operations or blocks described in connection with the disclosed methods, and/or other groups of operations associated with the functionality of the present disclosure.

In addition, the memory 2530 can comprise computer-accessible instructions and information (e.g., data, metadata, and/or programming code) that permit or otherwise facilitate operation and/or administration (e.g., upgrades, software installation, any other configuration, or the like) of the computing device 2510. Accordingly, as illustrated, the memory 2530 can comprise a memory element 2542 (labeled operating system (OS) instruction(s) 2542) that can contain one or more program modules that embody or include one or more operating systems, such as a Windows operating system, Unix, Linux, Symbian, Android, Chromium, or substantially any operating system suitable for mobile computing devices or tethered computing devices. In one aspect, the operational and/or architectural complexity of the computing device 2510 can dictate a suitable operating system. The memory 2530 also comprises a system information storage 2546 having data and/or metadata that permits or facilitates operation and/or administration of the computing device 2510. Elements of the OS instruction(s) 2542 and the system information storage 2546 can be accessible or can be operated on by at least one of the processor(s) 2514.

It should be recognized that while the functionality instructions storage 2534 and other executable program components, such as the OS instruction(s) 2542, are illustrated herein as discrete blocks, such software components can reside at various times in different memory components of the computing device 2510, and can be executed by at least one of the processor(s) 2514. In certain scenarios, an implementation of the incentive management component(s) 2536 can be retained on or transmitted across some form of computer-readable media.

The computing device 2510 and/or one of the computing device(s) 2570 can include a power supply (not shown), which can power up components or functional elements within such devices. The power supply can be a rechargeable power supply, e.g., a rechargeable battery, and it can include one or more transformers to achieve a power level suitable for operation of the computing device 2510 and/or one of the computing device(s) 2570, and components, functional elements, and related circuitry therein. In certain scenarios, the power supply can be attached to a conventional power grid to recharge and ensure that such devices can be operational. In one aspect, the power supply can include an I/O interface (e.g., one of the network adapter(s) 2518) to connect operationally to the conventional power grid. In another aspect, the power supply can include an energy conversion component, such as a solar panel, to provide additional or alternative power resources or autonomy for the computing device 2510 and/or at least one of the computing device(s) 2570.

The computing device 2510 can operate in a networked environment by utilizing connections to one or more remote computing devices 2570. As an illustration, a remote computing device can be a personal computer, a portable computer, a server, a router, a network computer, a peer device or other common network node, and so on. As described herein, connections (physical and/or logical) between the computing device 2510 and a computing device of the one or more remote computing devices 2570 can be made via one or more traffic and signaling communication links 2560, which can comprise wireline link(s) and/or wireless link(s) and several network elements (such as routers or switches, concentrators, servers, and the like) that form a local area network (LAN), a metropolitan area network (MAN), and/or a wide area network (WAN). Such networking environments are conventional and commonplace in dwellings, offices, enterprise-wide computer networks, intranets, local area networks, and wide area networks.

In one or more embodiments, one or more of the disclosed methods can be practiced in distributed computing environments, such as grid-based environments, where tasks can be performed by remote processing devices (computing device(s) 2570) that are functionally coupled (e.g., communicatively linked or otherwise coupled) through a network having traffic and signaling links and related network elements. In a distributed computing environment, in one aspect, one or more software components (such as program modules) can be located in both a local computing device (e.g. the computing device 2510) and at least one remote computing device.

In view of the aspects described herein, example methods that can be implemented in accordance with the present disclosure can be better appreciated with reference to the flowcharts in FIGS. 26-28. For purposes of simplicity of explanation, the example method disclosed herein is presented and described as a series of blocks (with each block representing, for example, an action or an operation in a method). However, it is to be understood and appreciated that the disclosed methods are not limited by the order of blocks and associated actions or operations, as some blocks may occur in different orders and/or concurrently with other blocks from those that are shown and described herein. For example, the various methods or processes of the disclosure can be alternatively represented as a series of interrelated states or events, such as in a state diagram. Furthermore, not all illustrated blocks, and associated action(s), may be required to implement a method in accordance with one or more aspects of the disclosure. Further yet, two or more of the disclosed methods or processes can be implemented in combination with each other, to accomplish one or more features or advantages described herein.

It should be appreciated that the methods of the disclosure can be retained on an article of manufacture, or computer-readable medium, to permit or facilitate transporting and transferring such methods to a computing device (e.g., a desktop computer; a mobile computer, such as a tablet, or a smartphone; a gaming console; a mobile telephone; a blade computer; a programmable logic controller; and the like) for execution and thus, implementation by a processor of the computing device or for storage in a memory device (or memory) thereof or functionally coupled thereto. In one aspect, one or more processors, such as processor(s) that implement (e.g., compile, link, and/or execute) one or more of the disclosed methods, can be employed to execute instructions (e.g., programming instructions) retained in a memory, or any computer-readable or machine-readable medium, to implement at least one of the one or more methods. The instructions can provide a computer-executable or machine-executable framework to implement the methods disclosed herein.

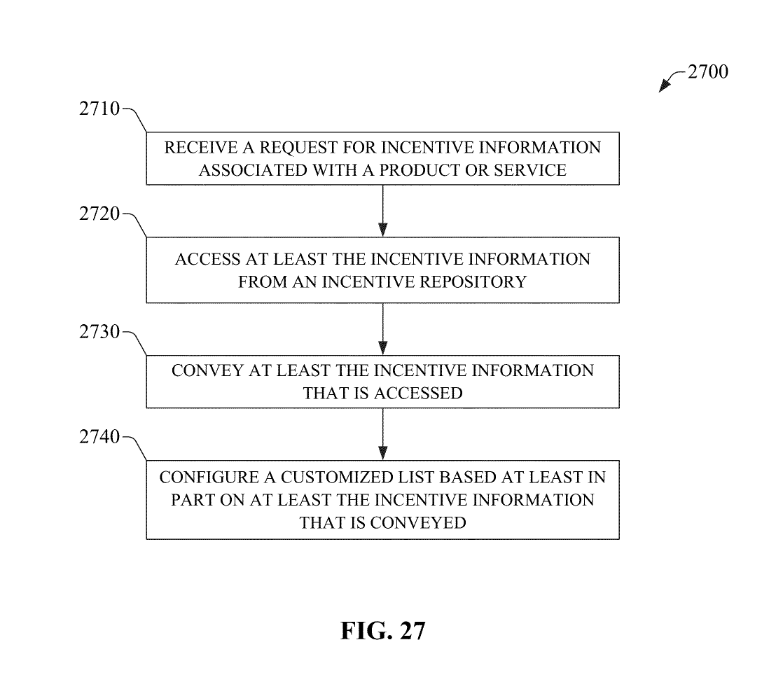

FIGS. 26-27 present flowcharts of example methods 2600 and 2700, respectively, for managing incentives in accordance with one or more aspects of the disclosure. Regarding example method 2600, at block 2610, incentive information can be received from a plurality of sources (e.g., the group of injection devices 110, which may be associated with a group of bloggers). The incentive information can be received at a system, or a portion thereof, comprising at least one processor and at least one memory device. The incentive information can comprise information indicative of financial incentives (e.g., a sale price) associated with respective products (such as CPGs). In certain implementations, the incentive information can comprise second information indicative of financial incentives associated with respective services.

At block 2620, a storage structure (e.g., a relational database or a non-relational database) comprising a plurality of records can be configured at the system or the portion thereof. The plurality of records can be representative of at least a portion of the incentive information. In one example, a record of the plurality of records can comprise a first information object indicative of an identifier for a product, a second information object indicative of the product, a third information object indicative of a financial incentive associated with the product, a fourth information object indicative of an out-of-pocket (OOP) price for the product, and a fifth information object indicative of an incentivized price for the object.

At block 2630, a benefit record that matches at least one of the plurality of records can be determined or otherwise identified at the system or the portion thereof. The benefit record can be representative or otherwise indicative of a coupon or other type of discount (e.g., cash back, monetary rewards, non-monetary rewards, a combination thereof, or the like).

At block 2640, at least one of the plurality of sources can be updated, at the system or the portion thereof, based at least in part on at least a portion of the storage structure (e.g., incentive/benefit storage 144).

In connection with example method 2700, at block 2710, a request for incentive information associated with a product (e.g., a CPG) or service can be received at a computing device (e.g., an injection device of the injection device(s) 110 or a consumption device of the consumption device(s) 150). The incentive information can be indicative of a financial incentive (e.g., a sale price, a coupon or discount, matchup content, a combination thereof, or the like) associated with the product or service. At block 2720, at least the incentive information can be accessed, by the computing device, from an incentive repository (e.g., network repository 140 comprising the incentive/benefit storage 144). At block 2730, at least the incentive information that is accessed can be conveyed by the computing device. In one aspect, conveying such information can comprise rendering at least the incentive information at the computing device. At block 2740, a customized list can be configured, at the computing device, based at least in part on at least the incentive information that is conveyed. In certain embodiments, the subject example method can include a block (not shown) at which advertisement and/or other promotional content can be conveyed, by the computing device, wherein at least a portion of the advertisement and/or the other promotional content can be based at least in part on the customized list. In addition or in the alternative, the advertisement and/or the other promotional content can be based at least in part on the historical behavior of an end-user associated with the computing device, where the historical behavior can be associated with generation of prior customized lists (e.g., shopping lists, favorite lists, or the like), purchasing habits of the end-user, redeemed benefits (e.g., coupons or other discounts), a combination thereof, or the like.

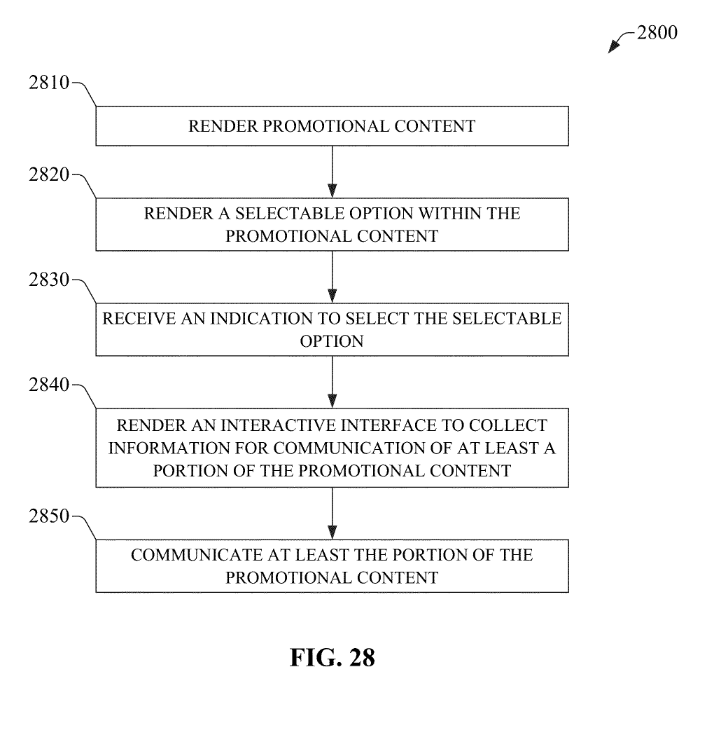

FIG. 28 presents a flowchart of an example method 2800 for consumption of promotional content in accordance with aspects of the disclosure. The subject example method can be implemented (e.g., executed) by a consumption device in accordance with this disclosure or any other computing device having at least one processor functionally coupled to at least one memory device. The at least one memory device can have computer-accessible instructions encoded thereon, where such instructions can embody or constitute the example method 2800. As illustrated, at block 2810, promotional content can be rendered at the computing device. In one example, the promotional content can include advertisement and/or other promotions. In an implementation in which the computing device embodies or includes a consumption device, at least one of the interface(s) 158 can render or otherwise present the promotional content. At block 2820, a selectable option can be rendered within the promotional content. At block 2830, an indication to select the selectable option can be received at the computing device. While illustrated in terms of a selectable option and selection thereof, it should be appreciated that in certain implementations, any actionable indicia can be rendered at block 2820 and an indication to actuate the actionable indicia can be received at block 2830.

At block 2840, an interactive interface can be rendered in response to receiving the indication to select the selectable option. In one aspect, the interactive interface can be rendered at the computing device that implements the subject example method, and can permit collecting or otherwise receiving input information for communication of at least a portion of the promotional content. At block 2850, at least a portion of the promotional content can be communicated. As an example, at least the portion of the promotional content can be communication via email, SMS, MMS, or other functionality (such as fax over IP) for electronic communication. In one embodiment, the computing device can include a communication unit that can permit the communication of at least the portion of the promotional content.

Various embodiments of the disclosure may take the form of an entirely or partially hardware embodiment, an entirely or partially software embodiment, or a combination of software and hardware (e.g., a firmware embodiment). Furthermore, as described herein, various embodiments of the disclosure (e.g., methods and systems) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read only memory (ROM); random access memory (RAM); magnetic disk storage media; optical storage media; flash memory, etc.

Embodiments of the operational environments and methods (or techniques) are described herein with reference to block diagrams and flowchart illustrations of methods, systems, apparatuses and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general purpose computer, special purpose computer, or other programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification or annexed drawings, or the like.

As used in this application, the terms “environment,” “system,” “architecture,” “interface,” “unit,” “module,” “component,” “source,” “node,” and the like are intended to refer to a computer-related entity or an entity related to an operational apparatus with one or more specific functionalities. Such entities may be either hardware, a combination of hardware and software, software, or software in execution. As an example, a component may be, but is not limited to being, a process running on a processor, a processor, an object, an executable portion of software, a thread of execution, a program, and/or a computing device. For example, both a software application executing on a computing device and the computing device can be a component. One or more components may reside within a process and/or thread of execution. A component may be localized on one computing device or distributed between two or more computing devices. As described herein, a component can execute from various computer-readable non-transitory media having various data structures stored thereon. Components can communicate via local and/or remote processes in accordance, for example, with a signal (either analogic or digital) having one or more data packets (e.g., data from one component interacting with another component in a local system, distributed system, and/or across a network such as a wide area network with other systems via the signal). As another example, a component can be an apparatus with specific functionality provided by mechanical parts operated by electric or electronic circuitry that is controlled by a software application or firmware application executed by a processor, wherein the processor can be internal or external to the apparatus and can execute at least a part of the software or firmware application. As yet another example, a component can be an apparatus that provides specific functionality through electronic components without mechanical parts, the electronic components can include a processor therein to execute software or firmware that provides, at least in part, the functionality of the electronic components. An interface can include input/output (I/O) components as well as associated processor, application, and/or other programming components. The terms “component,” “environment,” “system,” “architecture,” “interface,” “unit,” “module” and “node” can be utilized interchangeably and can be collectively referred to as functional elements.

In the present specification and annexed drawings, reference to a “processor” is made. As utilized herein, a processor can refer to any computing processing unit or device comprising single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit (IC), an application-specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. A processor can be implemented as a combination of computing processing units. In certain embodiments, processors can utilize nanoscale architectures such as, but not limited to, molecular and quantum-dot based transistors, switches and gates, in order to optimize space usage or enhance the performance of user equipment or other electronic equipment.

In addition, in the present specification and annexed drawings, terms such as “store,” storage,” “data store,” “data storage,” “memory,” “repository,” and substantially any other information storage component relevant to operation and functionality of a component of the disclosure, refer to “memory components,” entities embodied in a “memory,” or components forming the memory. It can be appreciated that the memory components or memories described herein embody or comprise non-transitory computer storage media that can be readable or otherwise accessible by a computing device. Such media can be implemented in any methods or technology for storage of information such as computer-readable instructions, information structures, program modules, or other information objects. The memory components or memories can be either volatile memory or non-volatile memory, or can include both volatile and non-volatile memory. In addition, the memory components or memories can be removable or non-removable, and/or internal or external to a computing device or component. Example of various types of non-transitory storage media can comprise hard-disc drives, zip drives, CD-ROM, digital versatile disks (DVD) or other optical storage, magnetic cassettes, magnetic tape, magnetic disk storage or other magnetic storage devices, flash memory cards or other types of memory cards, cartridges, or any other non-transitory medium suitable to retain the desired information and which can be accessed by a computing device.

As an illustration, non-volatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The disclosed memory components or memories of operational environments described herein are intended to comprise one or more of these and/or any other suitable types of memory.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and annexed drawings includes examples of systems, devices, and techniques that can provide generation of crowdsourced incentives and management thereof It is, of course, not possible to describe every conceivable combination of elements and/or methods for purposes of describing the various features of the disclosure, but it can be recognize that many further combinations and permutations of the disclosed features are possible. Accordingly, it may be apparent that various modifications can be made to the disclosure without departing from the scope or spirit thereof. In addition or in the alternative, other embodiments of the disclosure may be apparent from consideration of the specification and annexed drawings, and practice of the disclosure as presented herein. It is intended that the examples put forward in the specification and annexed drawings be considered, in all respects, as illustrative and not restrictive. Although specific terms are employed herein, they are used in a generic and descriptive sense only and not for purposes of limitation.

What is claimed is:

1. A method, comprising:
receiving, at a system comprising at least one processor and at least one memory device, incentive information from a plurality of sources, the incentive information comprising information indicative of financial incentives associated with respective products;
configuring, at the system, a storage structure comprising a plurality of records representative of at least a portion of the incentive information;
determining, at the system, a benefit record that matches at least one of the plurality of records; and
updating, at the system, at least one of the plurality of sources based at least in part on at least a portion of the storage structure.

2. The method of claim 1, wherein a record of the plurality of records comprises a first information object indicative of an identifier for a product, a second information object indicative of the product, a third information object indicative of a financial incentive associated with the product, a fourth information object indicative of an out-of-pocket price for the product, and a fifth information object indicative of an incentivized price for the object.

3. The method of claim 1, wherein the incentive information comprises second information indicative of financial incentives associated with respective services.

4. The method of claim 1, wherein the incentive information comprises information indicative of a sale or discounted prospective transaction, wherein one or more of the sale or the discounted prospective transaction are publically announced.

5. The method of claim 1, wherein the incentive information comprises information indicative of a sale or discounted prospective transaction, wherein one or more of the sale or the discounted prospective transaction are non-publically announced.

6. The method of claim 1, wherein the benefit record is representative of one or more of a coupon or a discount.

7. The method of claim 6, wherein the determining comprises determining at least one of the coupon or the discount that matched the at least one of the plurality of records, thereby yielding a satisfactory transaction value.

8. The method of claim 6, wherein the identifying comprises identifying at least one of the coupon or the discount that matched the at least one of the plurality of records, thereby yielding a maximal transaction value.

9. A system, comprising:
at least one memory device having instructions encoded thereon; and
at least one processor functionally coupled to the at least one memory and configured, by the instructions,
to receive incentive information from a plurality of sources, the incentive information comprising information indicative of financial incentives associated with respective products;
to configure a storage structure comprising a plurality of records representative of at least a portion of the incentive information;
to determine a benefit record that matches at least one of the plurality of records; and
to update at least one of the plurality of sources based at least in part on at least a portion of the storage structure.

10. The system of claim 9, wherein a record of the plurality of records comprises a first information object indicative of an identifier for a product, a second information object indicative of the product, a third information object indicative of a financial incentive associated with the product, a fourth information object indicative of an out-of-pocket price for the product, and a fifth information object indicative of an incentivized price for the object.

11. The system of claim 9, wherein the incentive information comprises second information indicative of financial incentives associated with respective services.

12. The system of claim 9, wherein the incentive information comprises information indicative of a sale or discounted prospective transaction, wherein one or more of the sale or the discounted prospective transaction are publically announced.

13. The system of claim 9, wherein the incentive information comprises information indicative of a sale or discounted prospective transaction, wherein one or more of the sale or the discounted prospective transaction are non-publically announced.

14. The system of claim 9, wherein the benefit record is representative of one or more of a coupon or a discount.

15. The system of claim 14, wherein the at least one processor is further configured to determine at least one of the coupon or the discount that matched the at least one of the plurality of records, thereby yielding a satisfactory transaction value.

16. The system of claim 14, wherein the at least one processor is further configured to determine at least one of the coupon or the discount that matched the at least one of the plurality of records, thereby yielding a maximal transaction value.

17. A method, comprising:
receiving, by a computing device, a request for incentive information associated with a product, the incentive information being indicative of a financial incentive associated with the product;
accessing, by the computing device, at least the incentive information from an incentive repository; and
conveying, by the computing device, at least the incentive information that is accessed.

18. The method of claim 17, further comprising configuring, at the computing device, a customized list based at least in part on at least the incentive information that is conveyed.

19. The method of claim 18, further comprising conveying advertisement based at least in part on the customized list.

20. The method of claim 17, wherein the conveying comprises rendering at least the incentive information.

21. A computing device, comprising:
at least one memory device having instructions encoded thereon; and
at least one processor functionally coupled to the at least one memory and configured, by the instructions,
to receive a request for incentive information associated with a product, the incentive information being indicative of a financial incentive associated with the product;
to access at least the incentive information from an incentive repository; and
to present at least the accessed incentive information.

22. The computing device of claim 21, wherein the at least one processor is further configured to configure a customized list based at least in part on at least the presented incentive information.

23. The computing device of claim 21, wherein the at least one processor is further configured to present promotional content based at least in part on the customized list.
